(19) United States
(12) Patent Application Publication
(10) Pub. No.: US 2005/0134710 A1
(43) Pub. Date: Jun. 23, 2005

(54) Imaging systems for use with patrol cars and patrol cars having such imaging systems

(76) Inventors: Toshiaki Nomura, Aichi-ken (JP); Hiroyuki Tanaka, Aichi-ken (JP); Tetsuya Hattori, Aichi-ken (JP); Atsushi Hotta, Aichi-ken (JP)

Correspondence Address: Douglas J. Christensen;Patterson, Thuente, Skaar & Christensen, P.A., 4800 IDS Center, 80 South Eighth Street, Minneapolis, MN, 55402-2100, US

(21) Appl. No.: 11/016,111

(22) Filed: Dec. 17, 2004

(30) Foreign Application Priority Data
Dec. 18, 2003 (JP) 2003-421014
Feb. 20, 2004 (JP) 2004-044156
Jul. 27, 2004 (JP) 2004-218764

(51) Int. Cl. H04N 5/225

(52) U.S. Cl. 348/240.99

(57) ABSTRACT

An imaging system for use with a patrol car includes at least one image pick-up device, a memory device, and a controller. The controller executes instructions to store image information captured by the image pick-up device in the memory device. Various operating modes of the imaging system may be selected based in part upon the operating conditions of the patrol car. Recording and transmitting of the image information may be performed manually or automatically, depending upon the operator of the system and the conditions of the patrol car. Both the interior of the patrol car (i.e., rear seat), and the environment outside of the patrol car (i.e., to the front and rear of the vehicle), may be recorded by the image pick-up systems. Additionally, automatic control such as 360° views upon reaching a desired destination may be performed based upon the configuration of the imaging system.

This application claims priority to Japanese patent application serial numbers 2003-421014, 2004-44156, and 2004-218764, the contents of which are incorporated herein by reference.

### BACKGROUND OF THE INVENTION

1. Field of the Invention

The present invention relates to imaging systems for use with patrol cars and also relates to patrol cars having such imaging systems.

2. Description of the Related Art

Japanese Laid-Open Patent Publication No. 11-312300 teaches an imaging system adapted to be mounted to an automobile. The imaging system includes a camera mounted on the automobile so that the information required for safe traveling can be collected in response to the traveling speed of the automobile. For example, such information may include the monitoring of the preceding automobile or the succeeding automobile and information with regard to the location of the white line on the road.

In recent years, there has been an increasing demand for patrol cars to have cameras mounted thereon in order to automatically record various pieces of information with regard to the locations traveled to by the patrol cars.

However, the camera of the above Japanese publication is intended to support the safe traveling of an ordinary automobile. Therefore, the camera is used for collecting information that may support the safe traveling of the automobile to which the camera is mounted. The collected information is necessary for supporting the safe traveling of the automobile at that immediate time, but the collected information is not recorded and reproducible later for the purposes of the safe traveling. In addition, although the camera of the above Japanese publication picks up images of the preceding and succeeding automobile and the location of the white line placed upon the road, the camera is not adapted to take up or record image information with regard to the places traveled to by the automobile.

In addition, in the case of a patrol car, such as police cars for example, a number of devices are mounted to the patrol car in order to provide various specialized police services. For example, such devices may include a hand-operated spotlight for illuminating areas in desired directions, a microphone, a loudspeaker for announcements to the outside of the police car, a siren, a radar speed measurement device, a police radio, and an emergency light.

Recently, there has been a proposal in some cases to mount a camera and a hard disc drive (HDD) to a police car. A controller having input buttons may also be mounted to the police car for operating the devices. The controller may preferably be disposed at a position where an operator can easily access the input buttons from either a driver's seat or a passenger seat. In general however, the controller for operating the devices used for the various police services has a relatively large size. Therefore, there has been a problem in that it is difficult to ensure enough space for placing the controller.

For example, Japanese Laid-Open Patent Publication No. 2002-357557 teaches an image pick-up device that is adapted to be mounted to an emergency vehicle, such as a police car for example. In this publication, a camera, a data-recording device, and a GPS (Global Positioning System) are mounted to the emergency vehicle. However, the overall system typically has a relatively large size and increased introduction costs with this arrangement.

As taught with this system, video information picked up during the traveling of the vehicle is recorded on a recording medium, such as a video tape and an HDD of a data recording device, together with information regarding the position of the vehicle at the time of the recording of the information. The devices mounted on the vehicle can communicate with an outside administration center via a communication network. For this purpose, communication sections 40 and 41 are respectively provided on the vehicle and at the administration center. The administration center also has a data-recording device. With this particular arrangement, the video data captured by the camera is recorded on the data-recording device of the vehicle. In addition, the video data is transmitted to the data-recording device of the administration center via the communication network. At the administration center, the video data is recorded on the data-recording device.

### SUMMARY OF THE INVENTION

It is accordingly an object of the present invention to teach improved image recording devices for use with patrol cars and patrol cars having such improved imaging systems.

According to one aspect of the present teachings, imaging systems are taught for mounting on patrol cars, such as police cars. The imaging systems include at least one image pick-up device having an optical axis. A direction-changing device serves to change the angle of the optical axis of the image pick-up device with respect to at least one of either a horizontal direction or a vertical direction. A zooming device serves to change a focal distance of the image pick-up device. At least one sensor detects a condition related to the vehicle and outputs a corresponding detection signal. An image memory device stores image information picked by the image pick-up device. A controller serves to select one of image pick-up modes in response to the detection signal and control at least one of either the direction-changing device or the zooming device based upon the detection signal, in order to capture images via the image pick-up device.

Therefore, the imaging systems can operate in various image-pick up modes in response to the detected condition(s) of the sensor(s). As a result, the operability of the imaging systems may be improved.

In one embodiment, the sensor is a speed sensor for detecting the traveling speed of the vehicle. The image-pick up modes includes a first mode that is selected when the controller determines a vehicle stop condition based upon the sensor detection signal. In the first mode, when the patrol car, traveling to a target place, has stopped at the target place, at an intersection, or a railroad crossing, the image around the stopped vehicle can be suitably captured and stored.

In addition to the speed sensor, the imaging systems may further include a positional information acquisition device, such as a GPS, operable to detect the current location of the vehicle and output a positional signal. The image-pick up modes includes a second mode that is selected when the controller determines a vehicle stop condition based upon the detection signal of the sensor and when the controller determines that the current vehicle position is within a predetermined district. If the target place is set to a predetermined district, the imaging systems may not operate in the first mode when the patrol car has temporarily stopped prior to reaching the target place. In addition, if the urban district is set to be the predetermined district, the imaging systems may not operate in the first mode to capture images while the patrol car is located in a suburban district. Suburban district images may be considered not as important during a typical patrol

In another embodiment, the sensor is an emergency sensor that detects the emergent response condition of the vehicle. The image-pick up modes includes a third mode that is selected when the controller determines an emergency response condition based upon a detection signal of the emergency sensor. In the third mode, the optical axis of the image pick-up device is directed in the traveling direction of the vehicle. Therefore, it is possible to suitably capture and record images even during an emergency response condition.

In a further embodiment, a first image pick-up device and a second image pick-up device are respectively operable to capture images inside and outside of the vehicle. The sensor is a passenger sensor that detects a passenger seated on the rear seat of the vehicle. The image-pick up modes includes a fourth mode that is selected when the controller determines the existence of a passenger on the rear seat based upon the passenger sensor detection signal. In the fourth mode, the images picked up by the second image pick-up device are stored in a memory unit. Consequently, the images of a passenger can be suitably captured and recorded.

In a still further embodiment, the sensor is a communication sensor that detects police radio communication. The image-pick up modes includes a fifth mode that is selected when the controller determines the establishment of the police radio communication based upon the detection signal of the communication sensor. As a result, the images of a policeman who is using a police radio transmitter can be automatically captured and recorded.

In a still further embodiment, the sensor includes a speed sensor for detecting the traveling speed of the vehicle and a steering angle sensor for detecting the steering angle of the vehicle. The controller is operable so as to estimate a direction of the line of sight of the driver of the vehicle based upon the signals from the speed sensor and the steering sensor. The image-pick up modes includes a sixth mode that is selected to control based upon the estimated direction of the sight line. Therefore, the images in the estimated direction of the sight line of the driver can be suitably and automatically captured and recorded.

In a still further embodiment, the sensor is a signal sensor for detecting a communication signal outputted from a portable communication device. The controller determines the direction of the portable communication device with respect to the vehicle based upon the detected communication signal. The image pick-up modes include a seventh mode that is selected to control based upon the direction of the portable communication device. Therefore, the images of a person or an object carrying the portable communication device can be automatically captured and recorded.

For example, the direction sensor may be a receiver for receiving the communication signal from the portable communication device.

In a still further embodiment, the sensor is a capacity sensor for detecting the remaining capacity of the power source of the imaging system. The image pick-up modes comprise an eighth mode that is selected when the remaining capacity of the power source is less than a predetermined value. For example, the operation of at least one of either the direction change device or the zooming device may be stopped in the eighth mode in order to save power.

In another aspect of the present teachings, patrol cars having imaging systems are taught. The imaging systems may include at least one image pick-up device, a memory device, and a controller The controller may execute instructions to record the image information captured by the image pick-up device in the memory device, and may execute instructions to control devices relating to patrol situations. Therefore, a driver or a passenger of the patrol car can operate the controller of the imaging system in order to function according to various patrol situations. By positioning the controller at a position that is easily accessible by either the driver or the passenger, it is not necessary for the driver or the passenger to lean or substantially reposition himself or herself toward the controller in order to control the devices relating to the patrol situations.

For example, the controller may have a control unit sized so as to be mounted into the existing storage space provided in a patrol car in order to accommodate the main body of commercial audio equipment.

In a still further aspect of the present teachings, the controller additionally includes a relay device connected between the image pick-up device and the control unit. The relay device may be disposed outside of the storage space and may be connected to at least one terminal device.

In a further aspect of the present teachings, patrol cars are taught that include imaging systems that include a positional information acquisition device, a transmitter, and an input device, in addition to at least one image pick-up device, a memory device, and a controller. The memory device serves to store image information captured by the image pick-up device. The positional information acquisition device functions so as to obtain the positional information of the patrol car and for example, may be a GPS. The transmitter serves to transmit image information and positional information to an auxiliary location. The input device enables the input of instructions to transmit information via the transmitter. The controller transmits the image information and the positional information via the transmitter after the corresponding instructions are inputted into the input device.

Preferably, the image information and the positional information arc transmitted in a single file format or in separate files.

In a still further aspect of the present teachings, the imaging system further includes a display device and a buffer memory. The display device functions to display the image information captured by the image pick-up device. The buffer memory serves to temporarily store the image information received from the image pick-up device or read from the memory device The transmitter transmits the image information stored in the buffer memory

Preferably, the image information and the positional information are stored in the buffer memory in a file format. The transmitter for example, may be a police radio transmitter.

In a still further aspect of the present teachings, patrol cars, such as police cars, are taught that include imaging systems. The imaging systems include at least one image pick-up device, the memory device, and the controller. The at least one image pick-up device is operable to capture images of at least one of either the outside or inside environment of the patrol car and to output the corresponding image information. The memory device serves to store the image information. The controller executes instructions to record the image information in the memory device and to output a synchronization signal to the image pick-up device. Consequently, the image information corresponding to one frame of an image is outputted from the image pick-up device to the controller in response to the cyclic period of the synchronization signal.

Therefore, the image information can be captured at the same time interval, according to the synchronization signal, even if a plurality of image pick-up devices are provided. In addition, altering the cyclic period of the synchronization signal conveniently varies the time intervals of the outputs of the image information from the image pick-up devices.

In a still further aspect of the present teachings, the patrol cars may additionally include a speed sensor for detecting the traveling speed of the patrol car. The controller is operable to vary the cyclic period of the synchronization signal in response to the detected traveling speed.

Therefore, the number of image frames per unit of time captured by the image pick-up device(s) can be altered in response to the traveling speed. For example, the number of frames of images per unit time may be reduced during lower speed traveling and may be increased during high speed traveling.

In a still further aspect of the present teachings, the controller monitors the remaining storage capacity of the memory device and indicates information regarding the remaining storage capacity to an operator of the imaging system. For example, such information may be the level of available capacity, a period for exchanging the memory device, or a period available for storing information. Therefore, it is possible to reliably prevent trouble such as the inability to store information in the memory device when an operator desires to store information during patrol.

Preferably, the controller monitors the remaining storage capacity each time the engine of the patrol car is started. The controller may output an alert signal if the remaining storage capacity is lower than a predetermined level or if the memory device is not connected to the controller. The inability of information storage can further be reliably prevented with this arrangement.

In a still further aspect of the present teachings, the controller includes a control unit and a relay device and executes instructions to store image information in the memory device. The relay device receives a power supply from a battery mounted in the patrol car. The power is supplied to the control unit, the image pick-up device, and the memory device, via the relay device. In addition, the relay device is arranged and constructed so as to control the start-up timing of each of the control unit, the image pick-up device, and the memory device.

The control unit, the image pick-up device, and the memory device, can receive a common power supply from the relay device. In a conventional automobile, power is supplied to various electric components via complex circuits including fuses and relays in each of the power supply lines to the electric components. In some cases, any of the individual power supply lines may be interrupted in response to a condition of the automobile In addition, the time or the start-up order or shutdown order of the electric components may be variable. As a result, the operation of the electric components may be unstable. Conversely, according to the present aspect of this invention, it is possible to reliably prevent unstable operation of the control unit, the image pick-up device, and the memory device, because the power is stably supplied via the relay device. Consequently, the imaging system can stably operate.

In a still further aspect of the present teachings, the controller includes a reading device that functions to obtain identification information of an operator of the imaging system and to store the read information in the memory device. For example, the reading device may read the identification information of a driver or a passenger of the patrol car. The identification information may be read from an IC tag that stores identification information relating to the person who is using the patrol car. The controller may store the read information and the time of the reading operation in the memory device. Consequently, it is possible to later identify a person who had previously used the patrol by analyzing the information stored in the memory device.

In a still further aspect of the present teachings, the controller has an internal clock. The internal clock functions to synchronize the time of the internal clock with the correct time at predetermined intervals. The controller may automatically conveniently perform the synchronizing operation when an engine of the patrol car is started for example. As a result, the accuracy of the time information corresponding to the image information stored in the memory device can be improved.

### BRIEF DESCRIPTION OF THE DRAWINGS

FIGS. 1(A) and 1(B) are views of image pick-up devices of a first representative embodiment and showing the image pick-up devices respectively mounted on and within a patrol car; and

FIG. 2 is a block diagram of the imaging system; and

FIG. 3 is a table showing different image pickup modes of the imaging system; and

FIG. 4 is a block diagram showing a general construction of second to fourth representative embodiments; and

FIG. 5 is an explanatory view showing image information and positional information that are transmitted in the same file; and

FIG. 6 is an explanatory view showing image information and positional information that are transmitted in different files; and

FIG. 7 is a block diagram similar to FIG. 4 but showing a fifth representative embodiment; and

FIG. 8 is a schematic view of a sixth representative imaging system and illustrating the connecting relation between an image memory section (including a control unit and a relay device) and image pick-up devices; and

FIGS. 9(A) and 9(B) are views showing the arrangement of the image pick-up devices, the control unit and the relay device on or within a patrol car; and

FIG. 10 is a view showing the internal construction of the control unit and the relay device and showing the connecting relation between these devices and the image pick-up devices; and

FIG. 11(A) is a front view of an operation panel of the control unit; and

FIG. 11(B) is a view showing arrangement of a group of operation buttons of the operation panel; and

FIG. 11(C) is a front view of the control unit with the operation panel opened; and

FIGS. 12(A) and 12(B) are explanatory views showing image information and positional information that are transmitted in the same file according to the sixth representative imaging system; and

FIGS. 12(C) and 12(D) are explanatory views showing image information and positional information that are transmitted in different files according to the sixth representative imaging system; and

FIGS. 13(A) to 13(C) are views showing various images displayed on a display device of the sixth representative imaging system.

### DETAILED DESCRIPTION OF THE INVENTION

Each of the additional features and teachings disclosed above and below may be utilized separately or in conjunction with other features and teachings to provide improved image pick-up devices. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

First Representative Embodiment

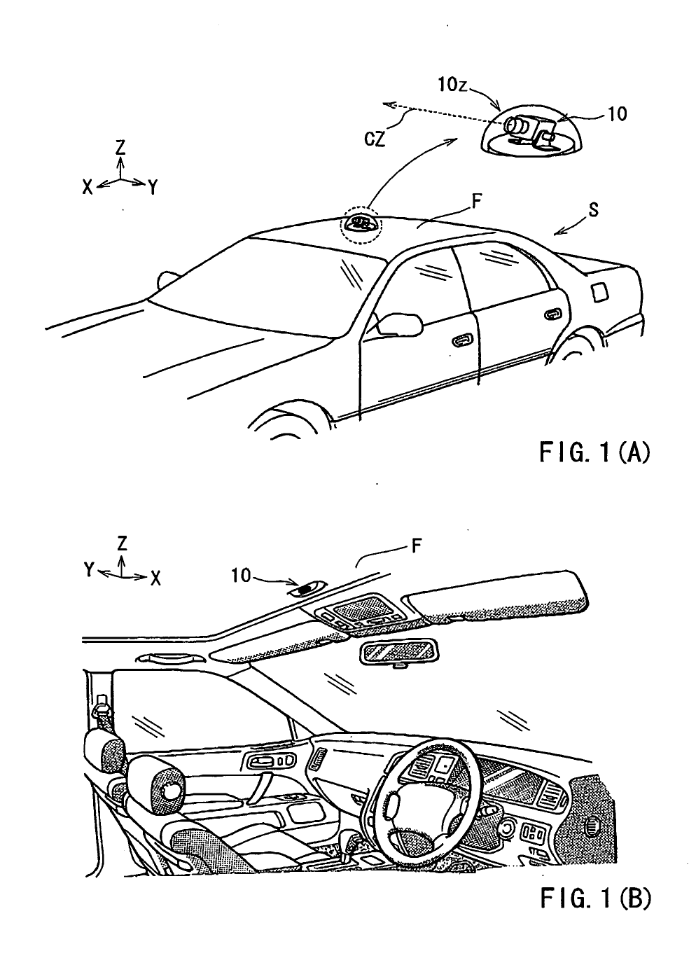

A first representative embodiment of the present invention will now be described with reference to FIGS. 1(A) and 1(B), and FIGS. 2 and 3. The general construction of the first representative embodiment will be first described with reference to these drawings.

General Construction

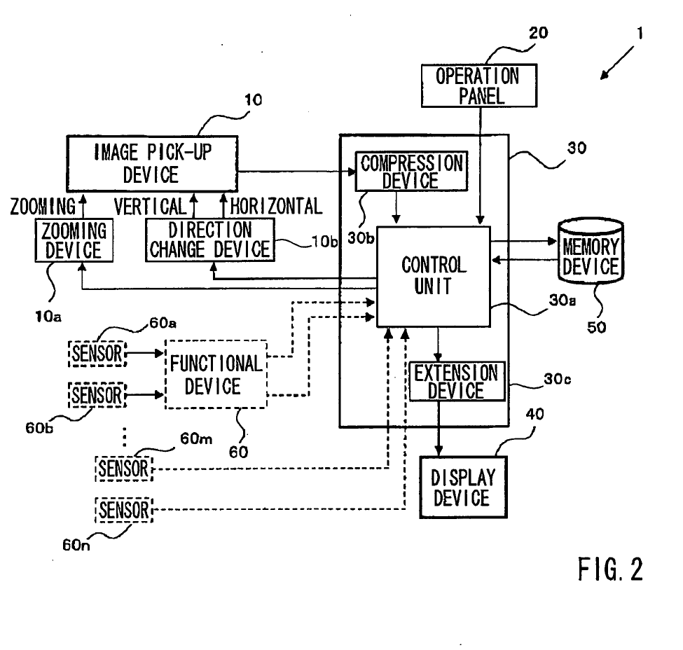

FIGS. 1(A) and 1(B) show different aspects of an image pick-up device 10 of a representative imaging system 1 (see FIG. 2) adapted to be mounted to a patrol car S (a police car in this representative embodiment). In FIG. 1(A), the image pick-up device 10 is mounted to an external surface of a vehicle roof R, in order to capture images of the external environment of the patrol car S. The image pick-up device 10 is covered by a protective cover 10z in order to prevent or minimize the influence of the outside conditions, such as the weather, upon the image pick-up device 10. The image pick-up device 10 has an optical axis CZ. The orientation of the optical axis CZ can be changed with regard to the horizontal direction and the vertical direction.

In FIG. 1(B), the image pick-up device 10 is mounted to an inner surface of the front portion of the vehicle roof R, in order to take up images of the inside of the patrol car S. In particular, this image pick-up device 10 is configured so as to capture the images of a passenger seated on a rear seat (not shown) of the patrol car S.

As shown in FIG. 2, the image pick-up device 10 may be a camera, such as a CCD camera. The image pick-up device 10 may output image information (taken at predetermined time intervals) to an image compression device 30b of a control unit 30. The image pick-up device 10 has a zooming device 10a and a direction changing device 10b. The zooming device 10a is operable to change the focal length of the image pick-up device 10. The direction changing device 10b is operable to change the direction (angle) or orientation of the optical axis CZ with respect to the horizontal direction and the vertical direction. A CPU 30a controls the zooming device 10a and the direction changing device 10b.

The control unit 30 has an expansion device 30c in addition to the CPU 30a and the compression device 30b. Therefore, the image information outputted from the image pick-up device 10 is compressed by the compression device 30b before inputting the information to the CPU 30a. The image information inputted to the CPU 30a is thereafter stored in a memory device 50 (e.g., a hard disc drive (HDD)). In addition, the image information inputted to the CPU 30a may be expanded by the expansion device 30c in order to be outputted to a display device 40 (e.g., an LCD). An operation panel 20 may be mounted within the interior of the cabin of the patrol car S. The operation panel 20 may output an operation signal to the control unit 30 so that the CPU 30a reads the image information stored in the memory device 50, and subsequently outputs the read information to the display device 40 via the expansion device 30c.

Various sensors 60a to 60n (e.g. a traveling speed sensor) and a functional unit 60 (e.g. a navigation unit) may be mounted on or within the patrol car S. The control unit 30 can obtain various types of information regarding the patrol car S associated with the control unit 30, from the sensors 60a to 60n and the functional unit 60. For example, the control unit 30 may be directly connected to the sensors 60a to 60n and the functional unit 60. Otherwise, the control unit 30 may be connected to the functional unit 60 via an in-vehicle LAN. In this way, the control unit 30 can monitor and record information regarding patrol car S.

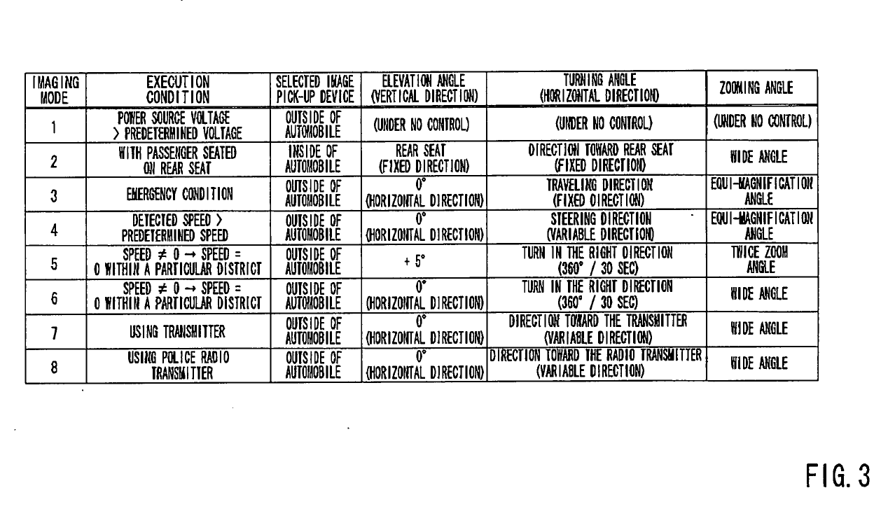

The imaging system 1, in particular the operation mode of the image pick-up device 10 can be automatically changed between various image capturing modes, as shown in FIG. 3, in response to various traveling conditions of the patrol car S. In FIG. 3, an elevation angle and a rotation angle may be controlled by the direction changing device 10b. Zooming is controlled by the zooming device 10a.

In response to the desired image pick-up or capturing modes, the image pick-up device 10 may be mounted to only the outside of the vehicle as shown in FIG. 1(A), mounted to only the inside of the vehicle as shown in FIG. 1(B), or mounted to both the interior and exterior of the patrol car S. However, for the purposes of explanation, the image pick-up modes will be described with reference to FIG. 3 assuming that the image pick-up device 10 is mounted to the inside and the outside of the patrol car S. In FIG. 3 is a table 100 in which the controls performed in image pick-up modes 1 to 8 are respectively listed in rows 101 to 108.

(First Image Pick-Up Mode)

In the first image pick-up mode, control of the image pick-up devices 10 is performed based upon the capacity of a power source, such as an in-vehicle battery. Unlike a commercial power source, the voltage of the in vehicle battery may abruptly change in response to the operating conditions of the vehicle and the environment (such as ambient temperature). Therefore, in order to operate in the first image pick-up mode, at least one of the sensors 60a to 60n is configured as a voltage sensor able to detect the voltage level of the power source. As shown in the first row 101 of the table 100 in FIG. 3, the control unit 30 determines the power source voltage based upon the signal from the voltage sensor or based upon a signal from the functional unit 60, to which the voltage sensor may be connected. If the power source voltage is lower than a predetermined voltage value, such as 8V, the control unit 30 stops the image capturing operation by the inside image pick-up device 10. Then only the image pick-up device 10 mounted to the outside of the patrol car S operates to pick up images. In addition, the control unit 40 stops the operations for controlling the elevation angle, the rotation angle, and the zooming ability of the outside image pick-up device 10.

(Second Image Pick-Up Mode)

In the second image pick-up mode, as shown in the second row 102 of table 100, the control unit 30 determines if a passenger is seated on the rear seat(s). If that determination is YES, the control unit 30 instructs the inside image pick-up device 10 to capture the image of the passenger(s) on the rear seat(s) and also to record the image in order to operate in the second image-pick up mode, the sensors 60a to 60n may include at least one passenger sensor that is operable to detect a passenger(s) seated on the rear seat(s). The control unit 30 may determine the presence of the passenger(s) on the rear seat(s) via the signal from the passenger sensor or via a signal from the functional unit 60 to which the passenger sensor may be connected. The inside image pick-up device 10 may capture the image with the elevation angle and the rotation angle fixed so as to orient the image pick-up device 10 towards the rear seats. In addition, the zooming may be fixed to a relatively wide angle. As examples, the passenger sensor may be a seating detection sensor (i.e., a pressure or weight sensor), an infrared sensor, or any other suitable sensor.

(Third Image Pick-Up Mode)

In the third image pick-up mode, the control unit 30 determines if the patrol car S is operating under emergency conditions, such as illuminating a rotary lamp and sounding a siren, as shown in the third row 103 of table 100. In order to operate in the third image pick-up mode, the sensors 60a to 60n may include an emergency sensor for detecting the lighting of the rotary lamp or a sensor for detecting the sounding of a siren. The control unit 30 may determine the emergency condition based upon a signal from the emergency sensor or a signal from the functional unit 60 to which the emergency sensor may be connected. If the determination is YES, the elevation angle of the outside image pick-up device 10 may be set to an angle of 0°. The rotating angle may be directed towards the traveling direction of the patrol car S. The zooming may be fixed to an equi-magnification (i.e., a one to one size relationship between the image viewed by a person and the image captured by the image pick-up device 10).

(Fourth Image Pick-Up Mode)

In the fourth image pick-up mode, the control unit 30 determines if the patrol car S is traveling at a speed exceeding a predetermined traveling speed, as shown in the fourth row 104 of table 100. If the traveling speed exceeds the predetermined speed, the horizontal direction of the outside image pick-up device 10 is changed so as to follow the direction corresponding to the steering angle. In order to operate in the fourth image pick-up mode, the sensors 60a to 60n may include a speed sensor and a steering angle sensor. The control unit 30 may determine if the traveling speed exceeds the predetermined speed based upon the signal from the speed sensor or a signal from the functional unit 60 to which the speed sensor may be connected. For example, the predetermined traveling speed may be 80 km/h. If the determination is YES (i.e., the actual vehicle speed exceeds 80 km/h in this example), the elevation angle of the outside image pick-up device 10 may be set to an angle of 0°. The zooming is fixed to an equi-magnification (i.e., a one to one size relationship between the image viewed by a person and the image captured by the image pick-up device 10). The rotation angle may be changed to correspond to the steering angle detected by the steering angle sensor.

Therefore, it is possible to capture and record images of the outside environment substantially in the focusing direction of the eyes of the driver of the patrol car S as the patrol car S is rushing to the scene.

(Fifth Image Pick-Up Mode)

In the fifth image pick-up mode as shown in the fifth row 105 of the table 100, the control unit 30 determines if the patrol car S has stopped after traveling. In order to operate in the fifth image pick-up mode, the sensors 60a to 60n may include a speed sensor, as in the fourth mode. The control unit 30 may determine if the patrol car S has stopped after traveling (i.e., if the traveling speed has been changed from a value (absolute value) of more than zero, to zero) based upon the signal from the speed sensor or a signal from the functional unit 60 to which the speed sensor may be connected. If the determination is YES, the elevation angle of the outside image pick-up device 10 may be set to an angle of 0°. The rotation angle may be set to an angular rate of 360°/30 sec in the right-hand direction (clockwise in this example). The zooming may be set for a wide-angle view.

Therefore, after rushing to the scene it is possible to automatically capture and record images of the outside environment around the scene when the patrol car S has stopped. In addition, when the patrol car S has stopped at an intersection for example, the images of the environmental conditions around the stopped car, such as the condition of the weather, people, and vehicles in the vicinity can be automatically picked up and recorded. This could increase the possibility that a policeman could record worthwhile images for later reference in the case at some time after the patrol without having to manually operate the image pick-up device 10.

(Sixth Image Pick-Up Mode)

The sixth image pick-up mode is similar to the fifth image pick-up mode in that the control unit 30 determines if the patrol car S has stopped after a period of traveling. However, the sixth image pick-up mode is different from the fifth image pick-up mode in that the control unit 30 determines if the patrol car S has stopped within a predetermined district, as shown in the sixth row 106 of the table 100. In order to operate in the sixth image pick-up mode, the sensors 60a to 60n may include a speed sensor as in the fourth mode. In addition, the functional device 60 may be a navigation unit that outputs a location signal to the control unit 30. The location signal from the navigation unit allows the control unit 30 to determine if the stopped position is within the predetermined district. If the control unit 30 determines that the patrol car S has stopped within the predetermined district after traveling, the elevation angle of the outside image pick-up device 10 may be set to an angle of 0°. The rotation angle may be set to an angular rate of 360°/60 sec in the right-hand direction. The zooming may be set to a twice-magnification zoom.

Therefore, by setting the scene as the predetermined district, it is possible to inhibit the sixth image pick-up mode imaging operation when the patrol car S has temporarily stopped along the way while otherwise rushing to the scene. In addition, by setting the predetermined district to the urban district, it would be possible to inhibit the sixth image pick-up mode imaging operation during a patrol of the suburban district. In many cases, the images of the environment surrounding a scene located in the suburban district are not worthwhile.

(Seventh Image Pick-Up Mode)

In the seventh image pick-up mode, the control unit 30 determines if a signal is being transmitted from an information transmitter (not shown) as listed in the seventh row 107 of table 100. For example, the policeman driving or riding in the patrol car S may hold the information transmitter. In addition, the information transmitter may be attached to a target to be traced. In order to operate in the seventh image pick-up mode, the functional unit 60 may be a receiver able to receive the signal from the information transmitter or the functional unit 60 may be a navigation unit. If the functional unit 60 is a receiver, the receiver may output a signal representing the direction of the transmission of the signal from the transmitter. If the functional unit 60 is a navigation unit, the navigation unit may also output a signal representing the direction of transmission of the signal from the transmitter based upon the information regarding the position of the transmitter and the information regarding the position of the patrol car S. Such a signal representing the transmitter signal transmission direction may be inputted into the control unit 30. In this way, if the control unit 30 determines that a signal is being transmitted from the transmitter, the elevation angle of the outside image pick-up device 10 may be set to an angle of 0°. The zooming may be set to a wide angle. The turning angle may be set to an angle corresponding to the transmitter signal transmission direction so as to direct the image pick-up device 10 towards the transmitter.

For example, if the policeman holds the transmitter, the image pick-up device 10 may be directed to him or her. If the transmitter is attached to a target, such as the trunk of a target automobile to be traced, the image pick-up device 10 may be directed to the target automobile.

(Eighth Image Pick-Up Mode)

In the eighth image pick-up mode, the control unit 30 determines if a signal is being received from a police radio transmitter (not shown) of another policeman, another police car, or a host police station, as shown in the eighth row 108 of table 100. In order to operate in the eighth image pick-up mode, the functional unit 60 may be a receiver for receiving the police radio transmitter signal. If the functional unit 60 is a receiver, the receiver may output a signal representing the transmission direction of the transmitter signal. Such a signal representing the transmission direction of the transmitter signal may be inputted to the control unit 30. In this way, if the control unit 30 determines that a signal is being transmitted from the police radio transmitter, the elevation angle of the outside image pick-up device 10 may be set to an angle of 0°. The zooming may be set to a wide angle. The turning angle may be set to an angle corresponding to the transmission direction of the police radio transmitter signal so as to direct the image pick-up device 10 toward the transmitter in the same manner as in the seventh representative embodiment.

(Parameters Changed in Response to Various Image Pick-Up Modes)

As described above, the parameters changed in response to the first to eighth image pick-up modes may include at least one of the focusing distance of the inside or outside image pick-up device 10, the angle within the horizontal plane of the inside or outside image pick-up device 10, and the angle within the vertical plane of the inside or outside image pick-up device 10. The focusing distance may be changed by the zooming device 10a. The horizontal and vertical angles may be changed by the direction change device 10b.

(Possible Alternative Arrangements of the First Representative Embodiment)

The present invention may not be limited to the representative imaging system 1 but may be modified in various ways as will be hereinafter described.

(1) The imaging system 1 is not necessary to operate in all of the above first to eighth image pick-up modes. Thus, the imaging system 1 may be constructed to operate in at least one of the image pick-up modes. If the imaging system 1 is constructed to operate in all of the above first to eighth modes, the process starting conditions shown in the first row 101 to the eighth row 108 of table 100 of FIG. 3 may be serially performed in order from the first row 101 to the eighth row 108

(2) Although the first representative embodiment has been described in connection with the representative imaging system 1 that includes the inside and outside image pick-up devices 10, the imaging system 1 may have only one of either the inside or outside image pick-up devices 10 in response to the desired image pick-up modes. For example, the imaging system 1 can operate in the first and third to eighth modes even if the imaging system 1 has only the outside image pick-up device 10. Alternatively, the imaging system 1 can operate in the second mode if the imaging system has only the inside image pick-up device 10.

(3) The process starting conditions and the method steps (for controlling the elevation angle, the turning angle, and the zooming angle) may not be limited to those shown in FIG. 3 but may be modified in various ways In addition, the numerical values indicated in the above representative embodiment should be considered to be possible example values and are not intended to limit the invention.

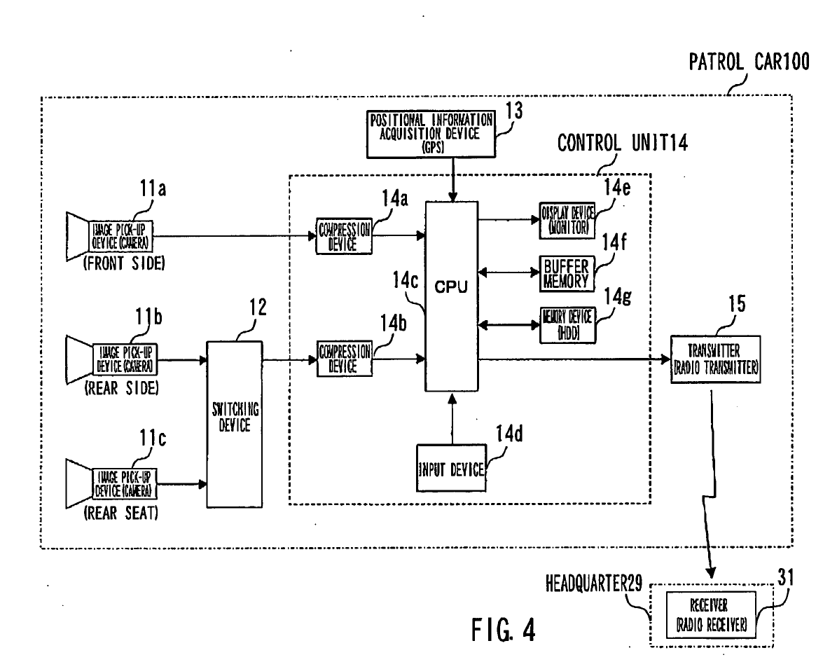

Second to fifth representative embodiments will now be described with reference to FIGS. 4 to 7. FIG. 4 shows the general construction of the second to fourth representative imaging systems. Referring to FIG. 4, a patrol car 100, such as a police car, has various in-vehicle devices. The various in-vehicle devices include three image pick-up devices 11a, 11b, and 11c such as video cameras, a switching device 12, a positional information acquisition device 13 such as a GPS, a control unit 14, and a transmitter 15 such as a radio transmitter.

Second Representative Embodiment

The second representative imaging system is configured to transmit the image information picked up by the image pick-up devices 11a, 11b and 11c, together with the positional information from the positional information acquisition device 13, in the same file for example.

The image pick-up device 11a is mounted within the patrol car 100 and is positioned to record images of the environment to the front of the patrol car 100, over the windshield (not shown in FIG. 1) of the patrol car 100. Each time the image is picked up by the image pick-up device 11a during a predetermined time, the image is transmitted to a compression device 14a of the control unit 14. The compression device 14a receives the images as image information consisting of a series of continuous frames of still images or a video image. The image pick-up device 11b is also mounted within the patrol car 100. Image pick-up device 11b is positioned to capture images of the environment to the rear of the patrol car 100 through the rear window (not shown in FIG. 1) of the patrol car 100. Similarly, the image pick-up device 11c is mounted within the patrol car 100. Image pick-up device 11c is positioned to capture images in the general location of the rear seat(s) of the patrol car 100. Each time an image is recorded by the image pick-up device 11b or 11c during a predetermined time, the image is transmitted to a compression device 14b of the control unit 14. The compression device 14b receives images as image information consisting of a series of continuous frames of still images or a video image. Thus, the switching device 12 operates to selectively transmit either the image information from the image pick-up device 11b or the image information from the image pick-up device 11c to the compression device 14b. If the compression device 14b is configured as a video image compression device, the compression device 14b may compress the received image information into compressed video image information, such as MPEG. If the compression device 14b is configured as a still image compression device, the compression device 14b may compress the received image information into compressed still image information, such as JPEG.

As described previously, the positional information acquisition device 13 may be a GPS that is known to receive information from an artificial satellite in order to enable identification of the current location of the GPS itself via a position representing signal (i.e., a signal representing latitude and longitude positions). If the GPS is configured to store address information related to the position representing signal, it is possible to identify the current position as a current address. The address information may be transmitted to the CPU 14c of the control unit 14. As described above, the control unit 14 includes the compression devices 14a and 14b, and the CPU 14c. In addition, the control unit 14 includes an input device 14d, a display device 14e, a buffer memory 14f, and a memory device 14g.

Each time the compression device 14a receives the image information that corresponds to one frame of the still images that are continuously recorded by the image pick-up device 11a at predetermined time intervals (e.g., 1/60 seconds), the compression device 14a compresses the received image information (i.e., the still image) and temporarily stores the compressed image information in the compression device 14a. When the amount of stored image information has reached a predetermined amount (such as a predetermined number of frames, e.g., five frames, of the still images), the compression device 14a transmits the predetermined amount of stored image information to the CPU 14c as a batch of image signals. Assuming that the switching device 12 has been switched so as to transmit the image information from the image take-up device 11b to the compression device 14b, the compression device 14b compresses and stores the image information corresponding to one frame of the still images captured by the image pick-up device 11b each time the compression device 14b receives image information corresponding to one frame. The compression device 14b transmits the stored information to the CPU 14c as a batch of image signals when the amount of stored information has reached a predetermined amount, such as a predetermined number of frames, e.g., five frames, of the still images.

When the CPU 14c receives the batch of image signals from each of the compression devices 14a and 14b, the CPU 14c affixes first and second information to each image signal in such a manner that the first and second information are included in the header of each image signal. First information relates to the identification number to identify each of the corresponding image pick-up device 11a, 11b, and 11c. Second information relates to the time that the image was captured to identifying the recording time of the received information. The CPU 14c then transmits the image information, which includes the image signals each having the first and second information and any other attribute information, in the header, to the buffer memory 14f, so as to be stored therein. The system also may include a clock device in order to identify the current time. In addition, the CPU 14c stores the positional information (obtained by the GPS 13) in a file format in the buffer memory 14f, together with the above image information.

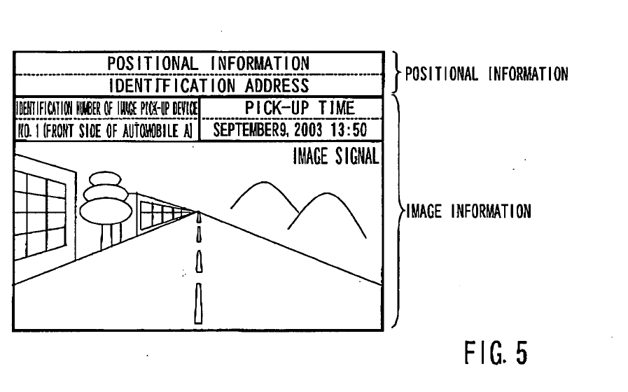

The image information combined with the positional information may be stored in the buffer memory 14f in a configuration schematically shown in FIG. 5. As shown in FIG. 5, the image information has an image signal with the first and second information (the image pick-up device identification number and the time of the image capture) included in the header of the image signal. In addition, positional information is affixed to the header of the image signal. Therefore, the image can be readily identified as to the image pick-up device used to capture the images and as to the time the image information was captured, by referring to the header of the image signal.

Preferably, the information may be stored in the buffer memory 14f in an overwrite manner. Consequently, as new information is received, the previous information is erased and the new information is overwritten in the memory section where the previous information had been stored. Therefore, the image information and the positional information once stored in the buffer memory 14f may in turn be stored in a memory device 14g, such as a HDD (Hard Disk Drive). In addition, the display device 14e may simply display the video images taken by each of the image pick-up devices 11a, 11b, and 11c, without any additional information. Further, the CPU 14c may operate so as to search or read particular image information from the memory device 14g, based upon a search condition such as tho image pick-up device number and the capture time. The read image information may then be displayed on the display device 14e.

Further, even if it is not possible to write the information in the memory device 14g, for example due to the vibrating of the patrol car 100, such information may be temporarily stored in the buffer memory 14f until the conditions affecting the memory device 14g have been changed to enable a writing operation. Therefore, the image information and the positional information may be stored without significant omissions, even if vibrations have been produced during the traveling of the patrol car 100. In this connection, the capacity of the buffer memory 14f may be conveniently determined by taking into account the possible duration of vibrations. For example, the duration of vibrations may be the duration required for the patrol car 100 to ride over a possible stepped surface on the road.

Furthermore, when an input operation is made by means of an input device 14d, such as a push button, the CPU 14c operates to combine the image information stored in the buffer memory 14f and the positional information (that may be stored in the same buffer memory 14f or may be stored in another memory device) in the same file and transmit the file to a receiver 31 of a fixed station 29, such as a police station, via a radio transmitter 15. Therefore, in a state of emergency, the fixed station 29 can receive the image information picked up by the controlled police car and can also receive the positional information related to the image information.

Thus, if a matter of emergency has arisen during the patrol by the patrol car 100 while the image of the environment is being captured by the in-vehicle imaging system, image information including the image information of the scene and the most current image information can be readily transmitted to the police station by the operation of the input device 14d in the patrol car 100. Therefore, persons in the police station can readily visually recognize the actual scene situation in order to issue appropriate instructions to the policemen at the scene. In addition, they can immediately send necessary backup cars to the scene, because the capturing location of the image can be readily recognized. Since the image information and the positional information are transmitted in the same file, the image information and the positional information can be handled as one file of information. Consequently, the one file of information facilitates the handling and management of the information.

Furthermore, the control unit 14 may be mounted within a storage space that is normally provided in the automobile for storing the main body of audio equipment. Therefore, if the main body of the audio equipment has already been installed, the control unit 14 may be mounted within the storage space after removing the audio equipment. In addition, audio equipment may be assembled together with the control unit 14 and may then be mounted within the empty storage space.

It is typically not possible to mount a conventional control unit within the storage space used for the installation of the main body of audio equipment because the size of a conventional control unit is relatively large. Therefore, the control must be mounted to another portion, such as the dashboard of the automobile. This may obstruct the driver's view and may hinder the driving operation of the driver. Further, the operability of the control unit is degraded because the driver may not be able to easily access the control unit. Conversely, the control unit 14 of this representative embodiment can be designed to have a small size in order to mount within the storage space prepared and designed for the main body of audio equipment. The representative embodiment is effective and advantageous in that the operability of the control unit 14, as well as the other in-vehicle devices that are necessary for police service, can be improved

Third Representative Embodiment

The third representative imaging system differs from the second representative embodiment in that the image information picked up by the image pick-up devices 11a, 11b, and 11c, is transmitted in a separated file apart from the positional information determined by the positional information acquisition device 13 (i.e., GPS). However, the components of the third representative embodiment are substantially the same as those of the second representative embodiment, which were described with reference to FIG. 4. Therefore, the third representative embodiment will be described with respect to only the transmission of the information file.

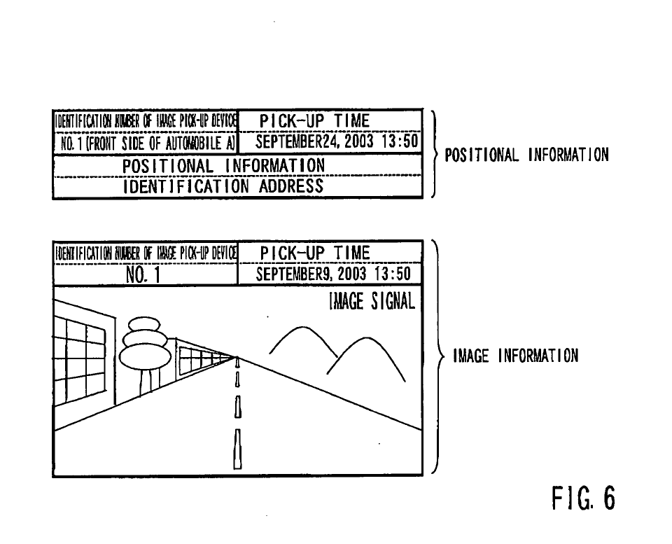

Similar to the second representative embodiment, the CPU 14c issues instructions to store the image information in the buffer memory 14f, preferably together with the positional information. The positional information may be stored in another memory device (not shown). In this representative embodiment, as shown in FIG. 6, the positional information is stored in a separate file apart from the file in which the image information is stored. Similar to the first representative embodiment, the image information has the image signal with the first and second information (i.e., the image pick-up device identification number and the time the image was captured) included in the header of the image signal. In this representative embodiment, the first and second information also are affixed to the positional information as shown in FIG. 6 The image information and the positional information are stored in the memory device 14g in the form of separate files and are transmitted to the receiver 31 also in the form of separate files. The image information and the positional information can be correlated to each other via the first and second information affixed to the information files.

Therefore, if it is desired to obtain the positional information from the image information, an operator may first identify the first and second information included in the image information. Next the operator may conduct a search for the positional information that matches the first and second information identified from the image information. The operator can subsequently identify the image capturing location from the located positional information that may be displayed on the display device 14e. Conversely, it is also possible to obtain the image information from the positional information by using a similar method.

In addition, the separation of files may reduce the amount of information included in the header of the information signal because only the first and second information are included in the header.

Fourth Representative Embodiment

The fourth representative imaging system is different from the first and second representative embodiments in that the image information captured by the image pick-up devices 11a, 11b, and 11c, and the positional information from the positional information acquisition device 13 (GPS), are sequentially transmitted. However, the components of the third representative embodiment are substantially the same as those of the second representative embodiment, which were described with reference to FIG. 4. Therefore, the fourth representative embodiment will primarily be described with respect to the transmission of information.

Similar to the second and third representative embodiments, the CPU 14c issues instructions to store the image information in the buffer memory 14f, preferably together with the positional information. However, the image information and the positional information are sequentially stored in the buffer memory 14f. Therefore, the CPU 14c issues instructions to perform the following steps. When the CPU 14c receives a predetermined amount of image information (i.e., a predetermined number of image frames) from the compression device 14a, the CPU 14c issues instructions to store such image information in the buffer memory 14f. Subsequently, the CPU 14c also issues instructions to store the positional information and the second information (capture time of the image) related to the stored image information. Similarly, when the CPU 14c receives a predetermined amount of image information (i.e., predetermined number of image frames) from the compression device 14b, the CPU 14c issues instructions to store such image information in the buffer memory 14f. Subsequently, the CPU 14c issues instructions to store the positional information and the second information (capture time of the image) related to the stored image information.

More specifically, six pieces of information, including the image information, related positional information, and second information (capture time) from the compression device 14a, and the image information, related positional information, and second information (capture time) from the compression device 14b, are sequentially stored as a block in the buffer memory 14f. The six information pieces are continuously handled as a block in further processing. Consequently, the information may be stored in the memory device 14g and may be transmitted to an external fixed location (e.g. the police station 29) in unit of a block consisting of six pieces of information.

Fifth Representative Embodiment

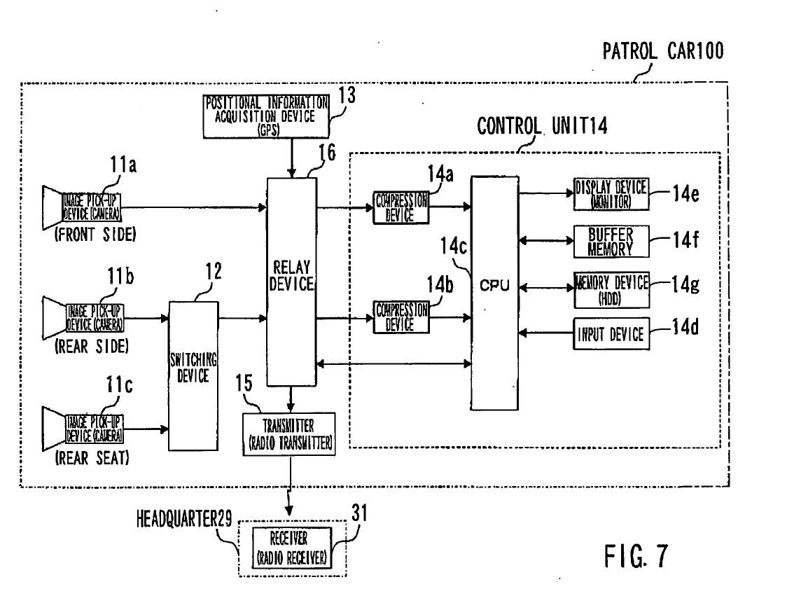

The fifth representative imaging system will now be described with reference to FIG. 7. The fifth representative imaging system is a modification of the second representative embodiment. Therefore, in FIG. 7, like elements are labeled with the same reference numerals as in the second representative embodiment. As shown in FIG. 7, according to the fifth representative embodiment, the CPU 14c is connected to various terminal devices (such as the image pick-up devices 11a, 11b, and 11c, the switching device 12, the positional information acquisition device 13, and the transmitter 15) via a relay device 16. In other words, the relay device 16 serves as an interface between the control unit 14 and the terminal devices. More specifically, the image pick-up devices 11a is connected to the control unit 14 via a relay device 16. The image pick-up devices 11b and 11c are connected to the control unit 14 via the switching device 12 and the relay device 16. The positional information acquisition device 13 (GPS) and the transmitter 15 are connected to the relay device 16. In other respects, the configuration of the fifth representative embodiment is the same as the first representative embodiment.

According to the imaging system of the fifth representative embodiment, a portion of the control panel of the control unit 14, in particular the display device 14e may be mounted within the storing space allocated for mounting audio equipment. The other part of the control panel may be placed on the floor, within the trunk, or any other convenient place. With this arrangement, an operator who is sitting on the driver's seat or a passenger's seat can easily access the part of the control panel that is to be operated for police service functions. In addition, the other part of the control panel can be conveniently mounted in another area of the patrol car 100, because of an increased freedom of choice for placing the remaining part of the control panel.

Also with the fifth representative embodiment, the image information and the positional information can be transmitted in the same file in the same manner as in the second representative embodiment, or transmitted in separate files in the same manner as in the third representative embodiment (except for including the intervention of the relay device 16). In addition, it is also possible to sequentially transmit the information as a block of six pieces of information in the same manner as in the fourth representative embodiment.

Preferably, the relay device 16 may be mounted on the dashboard within the patrol car 100. With this arrangement, cables extending from the terminal devices can be easily connected to and removed from the relay device 16. In addition, the relay device 16, mounted on the dashboard, may have a relatively small size because the main part of the control unit 14 is installed within the storing space of the audio equipment, i.e., within the instrumental panel. Although not shown in the drawings, some examples of additional terminal devices that may also be connected to the relay device 16 are a sound-collecting device (e.g., a microphone), an in-vehicle speaker, an emergency light, and a speed detection device for detecting the traveling speed of a preceding automobile.

(Possible Alternative Arrangements of the Second to Fifth Representative Embodiments)

Although the second to third representative embodiments have been described in connection with the imaging system as having three image pick-up devices, the number of image pick-up devices is not limited to three but may be one, two, or four or more. In addition, a new or existing in-vehicle navigation device may be used as the positional information acquisition device. Further, by incorporating a sound-collecting device, the sound may be captured by the collecting device and may be recorded as sound information together with the image information In such a case, the sound-collecting device may be connected to the CPU 14c of the control unit 14 via the relay device 16. Furthermore, by connecting the speed sensor of the patrol car 100 to the CPU 14c, it is possible to record the speed of the patrol car 100 together with the image information.

Sixth Representative Embodiment

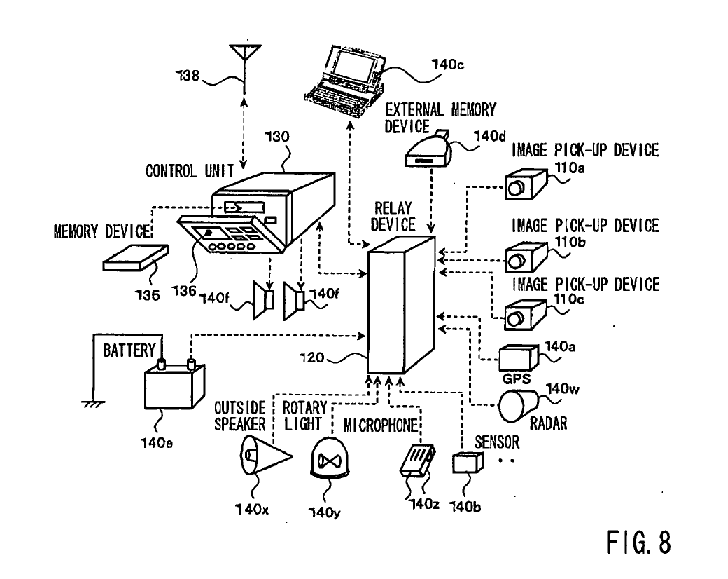

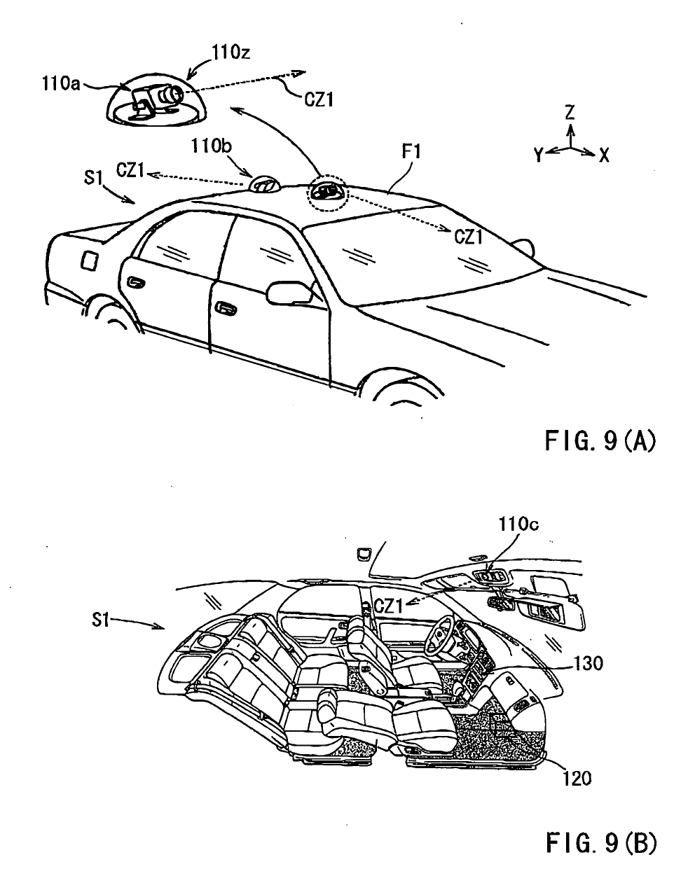

A sixth representative imaging system will now be described with reference to FIGS. 8 to FIGS. 13(A), 13(B), and 13(C). FIG. 8 shows a general construction of the sixth representative imaging system that is mounted on a patrol car S1, such as a police car (see FIGS. 9(A) and 9(B).

(Construction of Imaging System and Connection Network)

Similar to the fifth representative embodiment, the imaging system includes a control unit 130, a relay device 120, and image-pick up devices 110a, 110b, and 110c, such as CCD cameras. In this representative embodiment, a memory device 135, such as a HDD, is mounted within the control unit 130. The control unit 130 also has a display device 136.

The image pick-up devices 110a, 110b, and 110c, are connected to the relay device 120, so that the image information captured by the image pick-up devices 110a, 110b, and 110c, are inputted to the relay device 120. The relay device 120 compresses the inputted image information. The compressed image information is then inputted to the control unit 130 via a LAN cable (not shown) or any other suitable transmission device. The control unit 130 issues instructions to control the direction and/or the zooming angle of each of the image pick-up devices 110a, 110b, and 110c, and to record the image information inputted from the relay device 120 in response to the operation of the control unit 130 by the driver or a passenger of the patrol car S1. Also in this representative embodiment, the number of image pick-up devices is not limited to three but may be one, two, or four or more.

In this representative embodiment, the patrol car S1 is designed to have various police service equipment, such as a radar 140w, an external speaker 140x, a rotary lamp 140y, and a microphone 140z. The radar 140w may be used for measuring the traveling speed of a target automobile. The external speaker 140x may be used for emitting alert sounds, a siren, or voice commands. The rotary lamp 140y may be used for emitting an alert or emergency light. The microphone 140z may be used for inputting a users voice to the external speaker 140x. A positional information acquisition device 140a, such as a GPS, may also be connected to the relay device 120. In addition, a sensor 140b, such as a speed sensor of the patrol car S1, may be connected to the relay device 120. Therefore, the positional information of the patrol car S1, the speed information of a target automobile, and optional information, such as the speed of the patrol car S1, may be respectively inputted into the relay device 120 from the positional information acquisition device 140a, the radar 140w, and the sensor 140b.

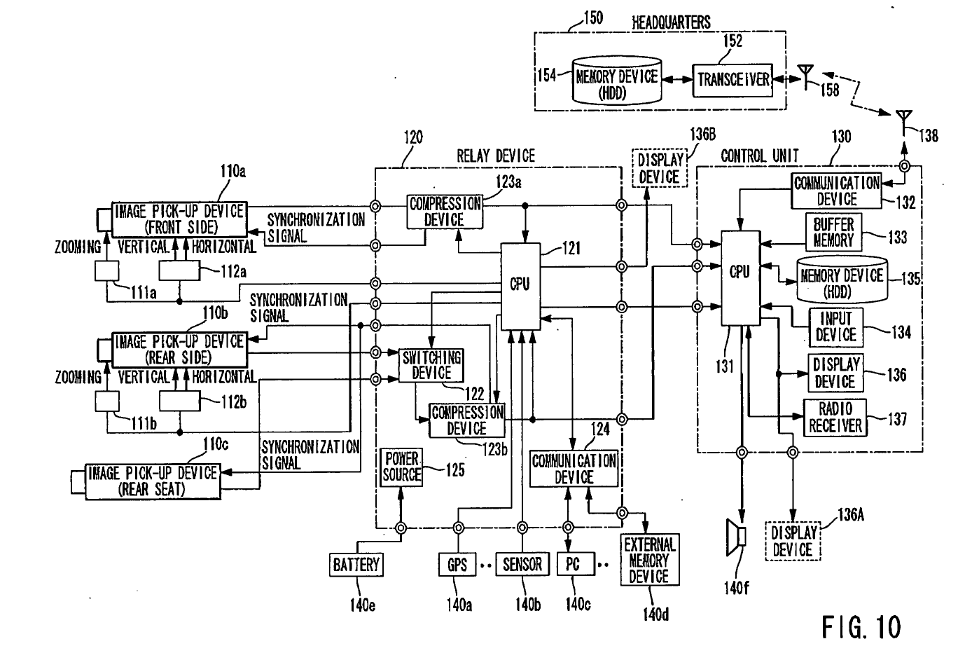

The relay device 120 may have at least one USB (Universal Serial Bus) terminal so that external devices, such as a terminal device 140c (a personal computer in this representative embodiment) and an external memory device 140d can be connected to the USB terminal(s) of the relay device 120 via a communication line. More specifically, the image information and/or any other information can be transmitted between a USB communication interface 124 (see FIG. 10) of the relay device 120 and the external devices via the communication line. In addition, the relay device 120 may be connected to a battery 140e of the patrol car S1. Power is supplied from the battery 140 to the relay device 120 and further to the control unit 130 and the image pick-up devices 110a to 110c. In addition to the devices noted above, various external devices can be connected to the USB terminal(s). For example, a printer having a USB communication interface may be directly connected to the USE terminal. Preferably, the control unit 130 may include an operation button(s) that is actuated by an operator (the driver or a passenger) for selecting and printing desired documents or images.

The control unit 130 is designed so as to allow the memory device 135 to be mounted within the control unit 130. The control unit 130 may be operable by the driver or a passenger of the patrol car S1 in order to record the image information outputted from the relay device 120 to the built-in memory device 135 or an external memory device 140d connected to the relay device 120. In addition, the control unit 130 is designed to enable the desired image information or any other information to be received and transmitted as a result of radio communication via an antenna 138, due to the driver or a passenger of the patrol car S1 operating the control unit 130.

In this representative embodiment, the control unit 130 is also designed to mount a radio receiver 137 (see FIG. 10), so that radiobroadcast voice information received by the antenna 138 can be outputted from the speaker 140f.

(Arrangement of Image Pick-Up Devices, Control Unit and Relay Device)

The arrangement of the image pick-up devices 110a to 110c, the control unit 130, and the relay device 120, on or within the patrol car S1 will now be described with reference to FIGS. 9(A) and 9(B).

The image pick-up device 110a is mounted on the patrol car S1 in a position suitable for capturing images of the outside environment to the front of the patrol car S1. More specifically, as shown in FIG. 9(A), the image pick-up device 110a is mounted on the front portion of the outer surface of the roof F1 of the patrol car S1. In addition, the image pick-up device 110a is covered by a dome-like cover 110z, and can pivot within a horizontal plane and a vertical plane in order to change the direction or orientation of an optical axis CZ1. In addition, the image pick-up device 110a is operable to change the zooming angle or degree of magnification within a predetermined range. The driver or a passenger of the patrol car S1 can control the orientation of the optical axis CZ1 and the zooming angle by means of the control unit 130. Although not shown in the drawings, the image pick-up device 110a may also be mounted within the patrol car S1, so that the image pick-up device 110a can capture the images of the outside environment through the windshield of the patrol car S1.

The image pick-up device 110b is mounted on the patrol car S1 in a position for capturing images of the outside environment to the rear of the patrol car S1. More specifically, as shown in FIG. 9(A), the image pick-up device 110b is mounted on the rear portion of the outer surface of the roof F1 of the patrol car S1. Similar to the image pick-up device 110a, the direction of the optical axis CZ1 and the zooming angle of the image pick-up device 110b can be controlled by the driver or a passenger of the patrol car S1, by means of the control unit 130. Although not shown in the drawings, the image pick-up device 110b may be mounted within the patrol car S1, so that the image pick-up device 110b can capture the images of the outside environment through the rear window of the patrol car S1.

The image pick-up device 110c is mounted within the patrol car S1 in a position for capturing images of the passenger(s) seated on the rear seat(s) of the patrol car S1 from the position forward of the rear seat(s). More specifically, as shown in FIG. 9(B), the image pick-up device 110c is mounted on the interior headliner trim of the patrol car S1, for example, in a position proximal to the rear view mirror. The driver or a passenger of the patrol car S1 can control the direction of the optical axis CZ1 and the zooming angle of the image pick-up device 110c by means of the control unit 130. However, the distance between the image pick-up device 110c and the target may not substantially change over a period of time. Therefore, the zooming angle of the image pick-up device 110c may be fixed at a wide angle. In addition, the direction of the optical axis CZ1 may also be fixed in a predetermined direction.

As described in connection with the previous representative embodiments, audio equipment is conventionally mounted within a storage space provided in the dashboard. For example, such a storage space is generally provided in the center console of the dashboard. The control unit 130 may be mounted within the storage space in place of the audio equipment. Alternatively, the radio receiver 137, shown in FIG. 10, may be mounted within the storage space. Of course, the control unit 130 may include other audio devices than the radio receiver 137.

With this arrangement, as described in connection with the previous representative embodiments, the control unit 130 may be positioned such that the operator (i.e., the driver or a passenger) of the control unit 130 can easily access the control unit 130 by simply reaching with his or her hand for changing the direction or orientation of the optical axes CZ1 and/or the zooming angle of each of the image pick-up devices, 110a to 110c. In addition, the operator can operate the radio receiver 137 by means of an input device 134 and a CPU 131.

As shown in FIGS. 8 and 10, various sensors and devices are connected to the relay device 120. The various sensors and devices may include those that cannot be mounted within the limited space of the dashboard.

In this representative embodiment, the relay device 120 is disposed within a space on the front side of the passenger's seat as shown in FIG. 9(B). However, the relay device 120 may be disposed at any other suitable location. For example, the relay device 120 may be placed below the passenger's seat, inside of the roof, on the dashboard, within the glove box, or within the trunk.

(Operations Performed by the Operator and Internal Construction And Operations of the Relay Device and Control Unit)

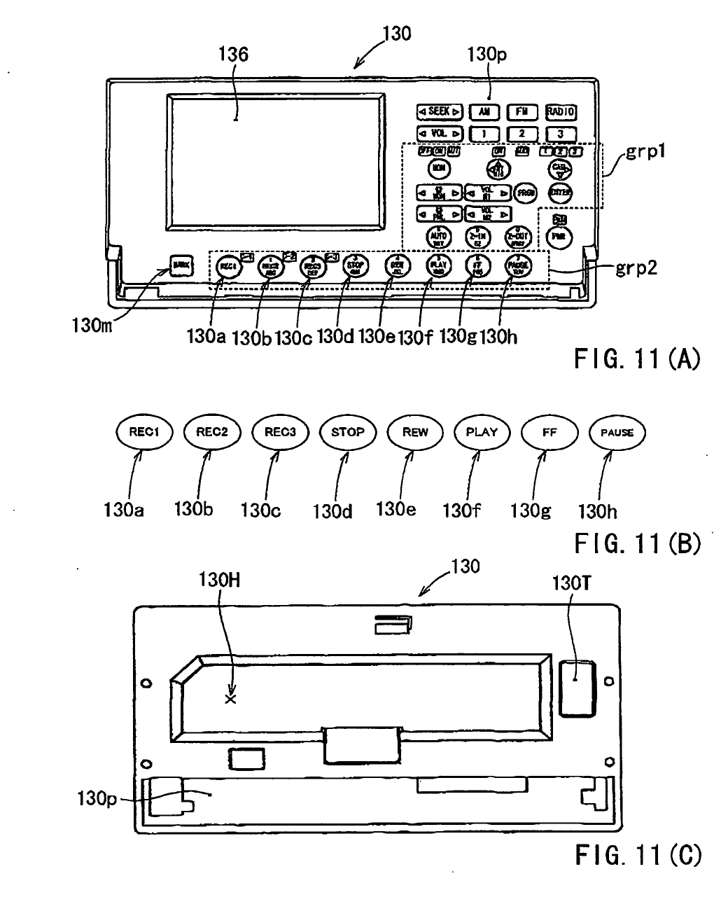

The operations performed by the operator (i.e., the driver or a passenger of the patrol car S1) and the functioning of the relay device 120 and the control unit 130 based upon the operations performed by the operator will now be described with reference to FIG. 10 and FIG. 11(A). FIG. 10 and FIG. 11(A) respectively show a block diagram of the imaging system and the front view of the operation panel 130p of the control unit 130.

As shown in FIG. 11(A), the display device 136 is positioned on the upper left side of the operation panel 130p. Various operation buttons, including a first button group grp1 and a second button group grp2, are respectively disposed on the right side and the lower side of the operation panel 130p. Therefore, if the driver seat is positioned on the left side of the operation panel 130p, the driver can easily watch the display of the display device 136 while the passenger can easily access and operate the operation buttons.

In FIG. 10, the marks ⊚, indicated with respect to the relay device 120 and the control unit 130, represent connectors. The relay device 120 and the control unit 130 are easily connected to and disconnected from each other via the connectors. In addition, other related devices, such as image pick-up devices 110a to 110c and the positional information acquisition device 140 can be easily connected and disconnected to the system via the connectors.

In this representative embodiment, the images of the outside environment are captured by two image pick-up devices 110a (front side) and 110b (rear side), while the images of the rear seat(s) within the patrol car S1 is captured by one image pick-up device 110c. However, one image pick-up device 110a may be used for recording the images of the outside environment, while two image pick-up devices 110b and 110c may be used for recording the images of the rear seat(s) In addition, although the switching device 22 operates so as to switch between two image pick-up devices, the number of the image pick-up devices may be increased, for example the switching device 22 may switch four or eight image pick-up devices.

(Switching Operation, Zooming Operation, and Direction Changing Operation of Image Pick-Up Devices)

The operator may input instructions by means of the input device 134 of the control unit 130 in order to select the image pick-up device that is capturing the images inputted to the control unit 130. In addition, the zooming angle and the orientation of the optical axis CZ1 of each of the image-pick up devices 110a and 110b can be controlled.

As shown in FIG. 11(A), the first button group grp1 buttons that are used for selecting from among the image pick-up devices 110a to 110c and for setting the direction of the optical axis CZ1 and the zooming angle of the selected pick-up device(s) The first button group grp1 further includes buttons that are used for selecting the image information (from among all of the image pick-up devices 110a to 110c) to be displayed on the display device 136. For example, the display device 136 may singly display the information from the image pick-up device 110a or may simultaneously display all of the information from all of the image pick-up devices 110a to 110c on a single split screen. Each of the buttons on the operation panel 130, including the first button group grp1 and the second button group grp2 may be designed for instructing plural types of functions. The instructions can be changed from one to another by a specific operation of the button. Preferably, the top surface of each button that an operator may touch with their fingers is coated with or made of a friction material, such as rubber, in order to prevent or minimize inadvertent operation due to slippage of the fingers.

By an input operation to the input device 134, the operator can control a zooming device 111a of the image pick-up devices 110a or 110b via the CPU 131 and CPU 121, in order to adjust the focal distance of the image pick-up devices 110a or 110b. Similarly, by an input operation to the input device 134, the operator can control a direction changing device 112a of the image pick-up device 110a or the image pick-up device 110b via the CPU 131 and the CPU 121, in order to adjust the orientation of the image pick-up device 110a or 110b with respect to the horizontal plane and/or the vertical plane.

Further, by an input operation to the input device 134, the operator can control the switching device 122 of the relay device 120 via the CPU 131 and the CPU 121, in order to select between the image pick-up device 110b (for taking images of the outside environment to the rear of the patrol car S1) and the image pick-up device 110c (for taking images within the interior of the patrol car S1). In other words, it is possible to select which images are to be inputted to the control unit 130 from among the image information of the image pick-up device 110b and the image information of the image pick-up device 110c. In this representative embodiment, the image information captured by the image pick-up device 110a is directly inputted to the control unit 130 without intervention of a switching device.

In the same manner as in the second representative embodiment, each time that the compression device 123a receives the image information corresponding to one frame of the still images that are continuously captured by the image pick-up device 110a at predetermined time intervals (e.g., 1/60 seconds), the compression device 123a compresses the received image information (i.e., the still image) and temporarily stores the compressed image information in the compression device 123a. When the stored image information has reached a predetermined amount (such as a predetermined number of frames, e.g., five frames, of still images), the compression device 123a transmits the predetermined amount of stored image information to the CPU 131 of the control unit 130 as a batch of image signals. If the switching device 122 has been switched to transmit the image information from the image pick-up device 110b to the compression device 123b, the compression device 123b compresses and stores the image information corresponding to one frame of the still images capture by the image pick-up device 110b each time that the compression device 123b receives image information corresponding to one frame. The compression device 123b transmits the stored information to the CPU 131 as a batch of image signals when the stored information has reached a predetermined amount, such as a predetermined number of frames, e.g., five frames, of the still images. If the switching device 122 has been switched to transmit the image information from the image take-up device 110c to the compression device 123b, the compression device 123b compresses and stores the image information corresponding to one frame of the still images captured by the image pick-up device 110c each time that the compression device 123b receives the image information corresponding to one frame. The compression device 123b transmits the stored information to the CPU 131 as a batch of image signals when the stored information has reached a predetermined amount, such as a predetermined number of frames, e.g., five frames, of the still images.

If the compression devices 123a and 123b are configured as video image compression devices, the received image information may be compressed into compressed video image information, such as MPEG. If the compression devices 123a and 123b are configured as still image compression devices, the received information may be compressed into compressed still image information, such as JPEG. Alternatively, the compression devices 123a and 123b may be configured to serve as video image compression devices and also as still image compression devices. In such a case, the operator may select either the video image compression function or the still image compression function by an input operation to the input device 134. Corresponding instructions may then be issued to the compression devices 123a and/or 123b via the CPU 131 and the CPU 121.

(Change of Number of Frames Per Unit Time)

In this representative embodiment, the CPU 121 is configured to output synchronization signals to the image pick-up devices 110a to 110c via the corresponding compression devices 123a and 123b. The output synchronization signals allow the time intervals of the output from the image pick-up devices 110a to 110c to be selectively determined. In addition, the cyclic period of the synchronization signals outputted from the CPU 121 may be directed from the CPU 131. This allows the cyclic period to be set by the input operation of an operator to the input device 134. Otherwise, the CPU 121 may automatically select the cyclic period based upon the detection signal from a sensor 140b, such as a speed sensor of the patrol car S1. Each of the image pick-up devices 110a to 110c outputs an information signal, corresponding to one image frame, to the relay device 120 each time that the synchronization signal is received from the CPU 121 of the relay device 120.

In the case where the sensor 140b is a speed sensor of the patrol car S1, the CPU 121 may change the cyclic period of the synchronization signals based upon the speed detected by the sensor 140b. The number of frames per unit time to be captured by each of the image pick-up devices 110a to 110c can be increased or decreased. For example, if the detected speed is within a range of 0 to 10 km/h, a range of 10 to 20 km/h, a range of 20 to 30 km/h, a range of 30 to 40 km/h, a range of 40 to 50 km/h and more than 50 km/h, the number of frames per unit time may be respectively set to 10 frames/second, 20 frames/second, 30 frames/second, 40 frames/second, 50 frames/second, and 60 frames/second.

With this determination, the number of frames per unit time is relatively low during the slow speed traveling of the patrol car S1. Conversely, the number of frames per unit time is relatively large during the high speed traveling. Therefore, the quality (i.e., such as the amount of detail captured by each series of images) of the reproduced images can be maintained irrespective of change of the traveling speed. In addition, the capacity of the memory device 35 can be effectively utilized, because unnecessary or surplus image frames can be reduced.

(Storing of Image Information and Automatic Correction of the Internal Clock)

In this representative embodiment, the information inputted to the control unit 130 can be stored in the memory device 135, mounted within the control unit 130, based upon the input operation to the input device 134 for the control unit 130.

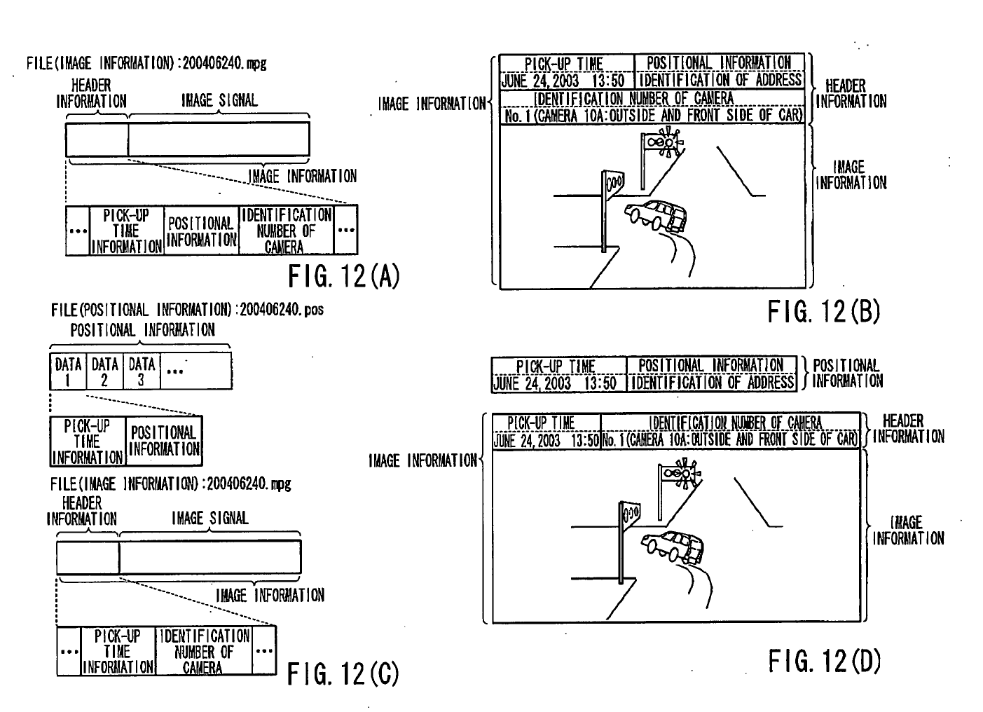

Similar to the second representative embodiment, when the CPU 131 receives a batch of image signals from each of the compression devices 123a and 123b, the CPU 131 affixes first information and second information to each image signal in such a manner that the first information and second information are included in the header of each image signal, as shown in FIGS. 12(A) and 12(C). The first information relates to the identification number to appropriately identify each of the image pick-up device 110a, 110b, and 110c. The second information relates to the time when the image has been captured to allow for later identification of the capture time of the received information. The CPU 131 then transmits image information, which includes image signals each having the first and second information and any additional attribute information located in the header, to be temporarily stored in the buffer memory 133.

The CPU 131 has a clock device or an internal clock (not shown) that enables the CPU 131 to recognize the current time. The CPU 131 also has a time matching device (not shown), so that the time indicated by the clock device can be corrected at predetermined time intervals. For example, the time matching device may utilize the time tone of a radio broadcast received by the radio receiver 137. The time tone can be checked by accessing the radio receiver 137 at predetermined time intervals. Otherwise, the time matching device may receive current time information from a fixed station 150, such as a police station, via the communication device 132. For example, the communication device 132 may receive the current time information each time the driver starts the engine of the patrol car S1. It is also possible that the fixed station 150 transmits the current time information to positively correct the current time from the fixed station 150.

In this representative embodiment, the CPU 131 may also add positional information to the header of the image signal as shown in FIG. 12(A). A simulated image on the display device 136 corresponding to FIG. 12(A) is shown in FIG. 12(B). Alternatively, the positional information together with the video capture time information may be stored in a file separate from the image information, as shown in FIG. 12(C). A simulated image on the display device 136 corresponding to FIG. 12(C) is shown in FIG. 12(D). The positional information can be obtained from the positional information acquisition device 140a (GPS). In the case that the positional information is stored in a separate file, new data (the positional information and the capture time information) may in turn be added at predetermined time intervals such as one minute.

In the case that the image information has been stored by a predetermined amount, the CPU 131 transfers the image information (including positional information stored in a separate file) in the buffer memory 133 to the memory device 135 when an instruction has been issued to store the information in the memory device 135.

In this representative embodiment, the second button group grp2 of the operation buttons (see FIG. 11(A)) includes a first sub-group of buttons and a second sub-group of buttons. The first sub-group includes buttons that are operated for instructing the selection of the desired image information from the image information obtained by the image pick-up devices 110a, 110b, and 110c, and for instructing the storing of the information in the memory device 135. For example, when the operator pushes an operation button 130a (REC1), the image information picked by the image pick-up device 10a may be stored or recorded in the memory device 135. The second sub-group includes buttons that are operated for instructing the reproduction (i.e., playback) of the information stored in the memory device 135. In addition to the buttons for manually storing the image information from the selected image pick-up device, an additional button may be provided for performing an automatic recording mode in order to automatically regularly store the image information that is inputted to the control unit 130.

FIG. 11(B) shows the second button group grp2 extracted from the operation buttons of the operation panel 130p shown in FIG. 11(A). The arrangement of the operation buttons 130a to 130h of the second button group grp2 is designed such that the operator (the driver or a passenger) can easily and readily record the images of the scene instantly upon based upon their judgment without incurring a high probability of making a substantial mistake in button operating.

In the arrangement shown in FIG. 11(B), the operation button 130d is operated for stopping the recording or reproducing process and is positioned substantially at the central position of the second button group grp2. The operation buttons 130a to 130c are positioned on the left-side of the operation button 130d. As previously described, the operation button 130a is pressed (or actuated) for the recording operation of the image information from the image pick-up device 110a. Similarly, the operation button 130b is pressed for the recording operation of the image information from the image pick-up device 110b. And finally, in this embodiment, the operation button 130c is pressed for starting the recording operation of the image information from the image pick-up device 110c.

The operation buttons 130e to 130h are positioned to the right of the operation button 130d and are operated for various functions in connection with the reproduction (or playback) of the image information. More specifically, the operation buttons 130e, 130f, 130g, and 130h, are respectively operated for rewinding, playing, fast-forwarding, and pausing. Preferably, the operation button 130d is configured so as to enable the operator to easily distinguish the operation button 130d from the other buttons 130a to 130c when the operator touches the operation button 130d. For example, the operation button 130d may have different surface roughness, different surface irregularity, a different contour, or a different size than the other buttons. In this way, the operator can easily identify the position of the operation button 130d. The operator should then be able operate any of the operation buttons 130a to 130h without having to take their eyes off of the road.

Further, as described in connection with the second representative embodiment, even if it is not physically possible to write the information in the memory device 135, for example due to excess vibrations of the patrol car S1, such information may be stored temporarily in the buffer memory 133 until the conditions of the memory device 133 have changed enough to allow the writing operation. In order to accomplish this function, a vibration sensor may be incorporated as a sensor 140b. This is particularly applicable in a case where the buffer memory 133 is an IC memory and the memory device 135 is a HDD (Hard Disk Drive). Therefore, the image information and the positional information may be stored without omission even if vibrations have been produced during the traveling of the patrol car S1. In addition, it is possible to reduce or minimize problems associated with the memory device 135. The capacity of the buffer memory 133 may be conveniently determined by taking into account the average length of time of potential vibration durations. The duration of vibrations, for example, may be the time period required for the patrol car S1 to ride over railroad tracks or a possible stepped surface on the road.

For example, if the sensor 140b has detected a magnitude of vibration greater than a predetermined amount, the recording operation in the memory device 135 may be interrupted for a predetermined period while the recording operation in the buffer memory 133 is still performed without interruption. After expiration of the predetermined period and with a magnitude of vibration less than a predetermined amount, the image information stored in the buffer memory 133 may be transmitted so as to be stored in the memory device 135.

As noted previously, the positional information acquisition device 140a may be a GPS that receives signals from an artificial satellite in order to identify the positional information (latitude and longitude) of the GPS itself. The GPS also may store the information corresponding to an address or map coordinates in relation to the current position. In this way, it is possible to identify the current position of the patrol car S1 via the address or the map coordinates. In general, the GPS transmits the positional information identified by an address or map coordinates with regard to the current position to the CPU 121 of the relay device 120 at predetermined time intervals, such as one-minute intervals.

The CPU 121 can communicate with a personal computer 140c and the external memory device 140d via the communication device 124 in order to transmit or receive image information. Therefore, the image information can be stored in the personal computer 140c or the external memory device 140d via the communication device 124. Preferably, the communication device 124 is a general-purpose interface designed to meet the USB (Universal Serial Bus) standard. Therefore, the communication device 124 may communicate with any from among various devices that have interfaces meeting the USB standard.

For example, if the relay device 120 is connected to the external memory device 140d, the operator can select the image information that is desired to be stored in the external memory device 140d. The desired information may be selected from the image information stored in the memory device 135. The operator can then store the desired information in the external memory device 140d by means of the input device 134 and the display device 136 of the control unit 130. In such a case, based upon the instructions issued from the input device 134, the CPU 131 may transmit the desired information from the memory device 135 to the external memory device 140d via the CPU 121.

Alternatively, if the relay device 120 is connected to a personal computer 140c, the operator can select the image information that is desired to be stored in the personal computer 140c from among the image information stored in the memory device 135. The operator can then store the desired information in the personal computer 140c by means of the input device (i.e., a keyboard) and the display device (i.e., a monitor) of the personal computer 140c. In such a case, based upon instructions inputted from the personal computer 140c via the CPU 121, the CPU 131 may transmit the desired information from the memory device 135 to the personal computer 140c via the CPU 121.

The image information captured by the image pick-up devices 110a to 110c may be displayed on the display device 136 in real time. In addition, particular information from among the image information stored in the memory device 135 may be read by performing a search utilizing the identification number of the image pick-up device or the capture time as a search condition. The particular information may then be displayed on the display device 136.

If a HDD is utilized as the memory device 135, it is advantageous if the HDD has a self-diagnostic function utilizing a technology known as “Self-Monitoring Analysis and Reporting Technology (SMART).” For example, the memory device 135 may perform the self-diagnostic function each time the engine of the patrol car S1 is started. The results of the self-diagnosis may then be displayed on the display device 136. Therefore the operator can easily obtain confirmation as to the functioning status of the memory device 135.

(Transmission of Image Information)

The operator can transmit the image information stored within the control unit 130 to the fixed station 150, such as a police station, by inputting instructions into the input device 134 of the control unit 130. As previously described, the image information may have an image signal along with the positional information included in the header (see FIGS. 12(A) and 12(B)) of the image signal. Alternatively, the positional information may be separated from the image information (see FIGS. 12(C) and 12(D)).

((Transmission of Image Information When Positional Information is Included in Image Information))

If the positional information is included in the header of the image signal, as shown in FIGS. 12(A) and 12(B), the CPU 131 may transmit the image information (with the positional information in the header) in one file that is stored in the buffer memory 133. The one file may be transmitted to the fixed station 150 via the communication device 132 and the antenna 138 in response to transmission instructions inputted to the input device 134. In this way, a predetermined amount of the current image information may be transmitted to the fixed station 150. The fixed station 150 may receive the transmitted information file via an antenna 158 and a transceiver 152.

Therefore, the fixed station 150 can receive the image information (to-ether with the positional information, the capture time information, and any other information included in the header) that has been or is being captured in an emergency by the imaging system of the patrol car S1, under control of the fixed station 150.

In other words, if an emergency situation occurs during a patrol by the patrol car S1 while the patrol car S1 is capturing images of the outside environment or the scene, the operator of the patrol car S1 can immediately transmit the image information of the scene to the fixed station 150 by simply operating the corresponding operation button of the control unit 130, such as the operation button 130m shown in FIG. 11(A).

In addition, a person at the fixed station 150 can readily visually recognize the situation of the scene in order to issue appropriate instructions to a person at the scene. In addition, the people at the fixed station 150 can immediately send necessary backup cars to the scene, because the pick-up position of the image can be readily recognized via the positional information included along with the image information. Since the image information and the positional information are transmitted in the same file, the image information and the positional information can be simply handled as information in one file. Therefore, the use of a single file facilitates the handling and management of the file. It can readily be known from the capture time information as to when the image was originally captured and in addition, it can readily be known from the identification number of the pick-up device as to which image pick-up device has been used for taking the image (see FIG. 12(A)).

((Transmission of Image Information When Positional Information is Separated from the Corresponding Image Information))

If positional information is not included in the header of the image signal but instead is stored in a separate file, as shown in FIGS. 12(C) and 12(1), the CPU 131 may transmit separate files of the image information and the positional information, which are stored in the buffer memory 133, to the fixed station 150 via the communication device 132 and the antenna 138. The transmission of the separate files is in response to the transmission instructions inputted into the input device 134. In this way, a predetermined amount of the current image information may be transmitted to the fixed station 150. The fixed station 150 may receive the transmitted information files via the antenna 158 and the transceiver 152.

Therefore, the fixed station 150 can receive the image information (together with the capture time information and any additional information included in the header), that has been or is currently captured and the positional information corresponding to the image information in an emergency situation, by the imaging system of the patrol car S1, under control of the fixed station 150.

In the same manner as described in connection with the image information including the positional information in the header, the operator of the patrol car S1 can immediately transmit the image information of the scene to the fixed station 150 by simply operating the corresponding operation button of the control unit 130, such as the operation button 130m shown in FIG. 11(A). A person at the fixed station 150 can therefore readily visually recognize the situation at the scene.

(Displaying on Display Device and Selection of Image Information to be Recorded in Memory Device)

The operator can select the display mode of the display device 136 and can also select the image information or any additional information to be displayed on the display device 136 by inputting the appropriate instructions to the input device 134 of the control unit 130.

For example, in an initial setting condition, the display device 136 may display only the image information captured by the image pick-up device 110a for recording the images of outside environment to the front of the patrol car S1. In such a case, the CPU 131 may direct the image information captured by the image pick-up device 110a and outputted from the compression device 123a to be displayed on the display device 136.

The operator may operate the input device 134 or may input instructions into the input device 134 in order to display on the display device 136 the image information captured by the image pick-up device 110b or the image pick-up device 110c. If the input device 134 is operated in order to display the image information captured by the image pick-up device 110b, the CPU 131 may operate the switching device 122 so as to select the image pick-up device 110b via the CPU 121. The image information captured by the image pick-up device 110b may then be inputted into the display device 136. Similarly, if the input device 134 is operated in order to display the image information captured by the image pick-up device 110c, the CPU 131 may operate the switching device 122 to select the image pick-up device 110c via the CPU 121. The image information captured by the image pick-up device 110c may then be inputted into the display device 136.

In addition, the image information stored in the memory device 135 may be read and reproduced for displaying on the display device 136 by an input operation in to the input device 134.

The image information captured by the image pick-up device 110a and outputted from the compression device 123a may be stored or recorded in the memory device 135 through an operation of the CPU 131 on the condition that the image information captured by the image pick-up device 110a is being displayed on the display device 136 when the operator operates the operation button 130a (REC1) shown in FIGS. 11(A) and 11(B).

Similarly, the image information captured by the image pick-up device 110b and outputted from the compression device 123b may be stored or recorded in the memory device 135 on the condition that the image information obtained by the image pick-up device 110b is being displayed on the display device 136 when the operator operates the operation button 130b (REC2) shown in FIGS. 11(A) and 11(B). The operator operates the operation button 130b in order to switch the switching device 122 to the image pick-up device 110b by an operation of the CPU 131 via the CPU 121.

Further, the image information obtained (captured) by the image pick-up device 110a and outputted from the compression device 123a and the image information obtained by the image pick-up device 110b and outputted from the compression device 123b may be stored or recorded in the memory device 135 on the condition that image information captured by the image pick-up device 110a is being displayed on the display device 136 when the operator operates both the operation button 130a (REC1) and the operation button 130b (REC2), shown in FIGS. 11(A) and 11(B). The operator operates operation buttons, 130a and 130b, in order to switch the switching device 122 to the image pick-up device 110b by an operation of the CPU 131 via the CPU 121.

Similarly, when the operator operates both the operation button 130a (REC1) and the operation button 130c (REC3) shown in FIGS. 11(A) and 11(B) in order to switch the switching device 122 to the image pick-up device 110c by an operation of the CPU 131 via the CPU 121, the image information obtained by the image pick-up device 110a and outputted from the compression device 123a and the image information obtained by the image pick-up device 110c and outputted from the compression device 123b may be stored or recorded in the memory device 135

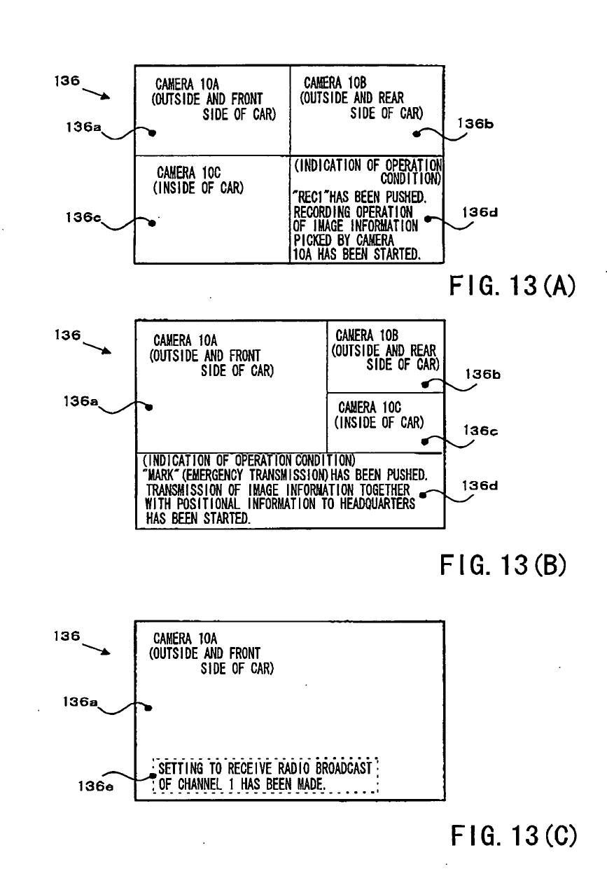

In addition, it is possible to change the display mode of the display device 136 to a mode shown in FIG. 13(A), or to a mode shown in FIG. 13(B). In the mode shown in FIG. 13(A), the display is split uniformly into four regions 136a to 136d. In the mode shown in FIG. 13(B), the display is non-uniformly split into four regions 136a to 136d.

With the display modes shown in FIGS. 13(A) and 13(B), operation conditions of the imaging system, such as the operation details inputted by the operator and the process details executed based upon the inputted operation are also shown in the display region 136d. Therefore, any mistake in operation and the possibility of overlooking a necessary operation can be reliably prevented.

Alternatively, as shown in FIG. 13(C), the operation conditions may be temporarily displayed in a particular region 136e within the display region 136a during a predetermined period of time, such as three seconds. In FIG. 13(C), the display region 136a occupies the entire display surface of the display device 136. The display region 136a displays the image captured by the image pick-up device 110a. A message is displayed in the region 136e to note that a radio broadcast is being received. For this case, it is possible to configure the system so that the displayed image information obtained by the image pick-up device 110a may be stored in the memory device 135 without storing the message information temporarily displayed within the region 136e.

Further, it is not necessary to display the operation conditions on the display device 136 in order to indicate the operation conditions to the operator. For example, an LED may be mounted to each operation button. The operated button can be illuminated or flashed in order to distinguish the operated button from the other buttons. More specifically, in the state where no button is operated, all the LEDs associated with the buttons may be lit. When the operator pushes any of the buttons, such as the operation button 130a (REC1), the LED associated with the pushed button may remain illuminated or flashing, while the LEDs associated with the other buttons may be switched off for a predetermined time period. After the predetermined time period has elapsed, all of the LEDs may be illuminated again. In this way, it is possible to reliably visually recognize the pushed button(s).

Furthermore, as shown in FIG. 10, a display device 136A and a display device 136B may be respectively connected to the relay device 120 and the control unit 130. Alternatively, only one of the display devices 136A and the display device 136H may be provided. The display device 136A and/or the display device 136B may be positioned at a suitable position, such as a position proximate to the rear seat(s), so that a passenger can see the displayed image on the display device 136A or 136B even if they cannot see the displayed image on the display device 136 of the control unit 130.

By connecting the display device 136B to the relay device 120, the CPU 121 may output signals to the CPU 131 instructing the CPU 131 to obtain the image information. The CPU 131 then transmits the image information that is outputted to the display device 136 to the CPU 121. The CPU 121 outputs the image information to the display device 136B.

(Indication of Remaining Storage Capacity of Memory Device)

The CPU 131 may be operable to detect the remaining capacity of the memory device 135. In addition, the CPU 131 may then transmit information regarding the remaining capacity to the display device 136. For example, such information may include the number of bytes of the remaining capacity, the remaining time available for storing, and an anticipated period for exchange.

The time for displaying the information with regard to the remaining capacity may preferably be set to the time when the engine of the patrol car S1 is started. To achieve this function, it is further preferable that the CPU 131 automatically detects the remaining capacity of the memory device 135 for displaying on the display device 136 in response to the starting of the engine.

Further, it is preferable that the display device 136 or the speaker 140f outputs an alert if the remaining capacity of the memory device 135 is less than a predetermined level, or if the memory device 135 is not connected to the control unit 130 when the engine of the patrol car S1 is started. Consequently, it is possible to reliably prevent a situation in which the image information cannot be stored when the operator operates the imaging system so as to record the image information, after the patrol car S1 has reached a target location.

(Mounting and Exchanging of Memory Device)

The operation for mounting and exchanging the memory device 135 will now be described with reference to FIG. 11(C). FIG. 11(C) shows the configuration where the operation panel 130p of the control unit 130 has been tilted opened to the side of the operator (i.e., in a direction extending perpendicular to the sheet of FIG. 11(C)). Alternatively, the control unit 130 may be designed such that the operation panel 130p is opened to the left, the right, or the direction opposite to the direction shown, of the control unit 130.

The operator may open and close the operation panel 130 by a predetermined operation. The operator can remove the memory device 135 (not shown in FIG. 11(C)) from the control unit 130 via an access opening 130H by pushing an operation button 130T when the operation panel 130p is opened. A connector (not shown) is disposed on the backside of the access opening 130H in order to connect to the memory device 135. When the operator inserts the memory device 135 into the access opening 130H and Connects the memory device 135 to the connector, the connector automatically moves to a predetermined position within the control unit 130. Therefore the memory device 135 can be suitably positioned within the control unit 130.

The capacity of the memory device 135 may be appropriately chosen from various amounts of memory, for example, some common current memory amounts are 20 GB, 30 GB, and 40 GE.

In addition, it is preferable that only authorized people are able to make changes to the memory device 135 (i.e., replacement, etc.). In order to restrict access to the memory device 135, the control unit 130 may be designed such that the operation panel 130p is only opened when a predetermined password has been inputted via suitable operations buttons provided on the operation panel 130p. Alternatively, a specific operation button may be provided that functions to enable the other operation buttons to be used for various control operations in order to serve as password input buttons. For example, by operating the specific operation button, the operation button 130b may be used for inputting the numeral “1” or alphabetic characters such as “A,” “B,” and “C.”

(Central Control of Power Source)

The relay device 120 may have a power source 125 that is connected to a battery 140e of the patrol car S1. The power supplied to the power source 125 from the battery 140e may be used for operating the relay device 120, the control unit 130 including the memory device 135, and the image pick-up devices 110a to 110c, etc. In other words, the power source 125 serves as a common power source for the various electric devices of the imaging system. Therefore, it is possible to reliably prevent accidental interruptions of the power supply to any of the electric devices. Such accidental interruption may be caused in some cases depending on the condition of the patrol car S. In addition it is also possible to reliably prevent unstable operation of the imaging system due to the potential delay of start-up or shut-down operations of different power sources.

(Wireless Communication)

In the case where the patrol car S1 is a police car, the fixed station 150 may be a police station of a particular district. In such a situation, the communication device 132 of the control unit 132 may be a wireless receiver and transmitter for police radio communication. For example, the microphone 140z shown in FIG. 8 may be used for police radio communication. The communication device 132 can transmit voice information to the transceiver 152 of the fixed station 150 and receive voice information from the transceiver 152 via a police wireless communication line. In addition, if the operation for “transmission of image information” described previously has been made, the communication device 132 may transmit the image information to the transceiver 152 of the fixed station 150 via the police wireless communication line.

In addition, the operator can transmit voice information from the microphone 140z to a portable transceiver carried by a person, such as a policeman, via the relay device 120 and the control unit 130 (in particular, the communication device 132 of the control unit 130). The voice information that has been transmitted from the communication device 132 to the transceiver 152 of the fixed station 150 or the portable transceiver and the voice information that has been received by the communication device 132 from the transceiver 152 or the portable transceiver may be stored in the memory device 135 by the operation of the control unit 130, such as the operation of the related operation button. Similarly, the voice information inputted to the microphone 140z by the operator can also be stored in the memory device 135.

In this way, wireless voice communication information between the microphone 140z and the transceiver 152 of the fixed station 150 or the portable transceiver, can be stored in the memory device 135 by the operator of the patrol car S1. Conveniently, the system may be configured such that it is possible to store only the voice information inputted to the microphone 140z, so that the operator can record voice information in the form of daily report data or the like.

(Record of Passenger)

Since many people may use the patrol car S1, it is preferable to record information concerning the identities of people who use the patrol car S1 and information regarding the time when the people use the patrol car S1. Therefore, each person who uses the patrol car S1 may preferably carry an IC tag. The IC tag may be a wireless tag of a non-contact type and may store identification information of the person who carries the IC tag. In connection with the IC tags, a reader for reading the identification information may be mounted to the control unit 130 or the relay device 120.

For example, the control unit 130 may read the identification information of the person riding in the patrol car S1 at predetermined time intervals, such as five-minute intervals. The control unit 130 may then store the read information in the memory device 135 together with the time that the reading operation was performed. Based upon the stored identification information and the reading time information, it is possible to easily extract information with regard to the particular occupants of the patrol car S1 and the time that they were in the vehicle from the stored information. The time information may not be necessary if the memory device 135 is exchanged for another memory device every time or at each time a new patrol is undertaken.

Further, it is possible to reference the identification information prior to the starting of the engine of the patrol car S1. In connection with this situation, information indicating the correlation between each piece of identification information and each person may be stored in the control unit 130, the relay device 120, or the fixed station 150. For example, the control unit 130 may read the identification information before starting the engine by means of a suitable reading device. In the case where the correlation information is stored in the control unit 130, the control unit 130 may directly refer to the correlation information in order to compare the identification information with the correlation information.

In the case where the correlation information is stored in the relay device 120, the identification information read by the control unit 130 may be transmitted to the relay device 120. The comparison may then be made at the relay device 120. Subsequently, the result of comparison may be transmitted to the control unit 130.

In the case that the correlation information is stored at the fixed station 150, the identification information read by the control unit 130 may be transmitted to the transceiver 152 of the fixed station 150. The comparison may then be made at the fixed station 150. Subsequently, the result of comparison may be transmitted to the control unit 130.

1. An imaging system for mounting on a patrol car, comprising:
at least one image pick-up device having an optical axis; and
a direction changing device arranged and constructed to change an angle of the optical axis of the image pick-up device with respect to at least one of either a horizontal direction or a vertical direction; and
a zooming device arranged and constructed to change a focal distance of the image pick-up device; and
at least one sensor arranged and constructed to detect a condition related to the patrol car and to output a detection signal; and
an image memory device arranged and constructed to store image information captured by the image pick-up device;
a controller arranged and constructed to select one of image pick-up modes in response to the detection signal and to control at least one of either the direction changing device or the zooming device according to the selected pick-up mode in order to capture images by the image pick-up device.

2. The imaging system as in claim 1, wherein the patrol car is a police car.

3. The imaging system as in claim 1,
wherein the at least one sensor comprises a speed sensor to detect a traveling speed of the patrol car, and
wherein the image pick-up modes comprise a first mode that is selected when the controller determines a stop condition of the patrol car based upon a detection signal of the speed sensor.

4. The imaging system as in claim 3, further comprising a positional information acquisition device operable to detect the current position of the patrol car and to output a positional signal;
wherein the image pick-up modes further comprises a second mode that is selected when the controller determines a stop condition of the patrol car based upon the detection signal of the speed sensor and when the controller determines the current patrol car position to be within a predetermined district based upon the positional signal.

5. The imaging system as in claim 1;
wherein at the least one sensor comprises an emergency sensor that detects an emergency response condition of the patrol car, and
wherein the image pick-up modes comprise a third mode that is selected when the controller determines the emergency response condition based upon a detection signal of the emergency sensor, and
wherein the optical axis of the image pick-up device is oriented in a traveling direction of the patrol car in the third mode.

6. The imaging system as in claim 1;
wherein the at least one image pick-up device comprises a first image pick-up device and a second image pick-up device respectively operable to capture images of the outside and inside of the patrol car; and
wherein the at least one sensor comprises a passenger sensor that detects a passenger seated on a rear seat of the vehicle; and
wherein the image pick-up modes comprise a fourth mode that is selected when the controller determines the existence of the passenger on the rear seat based upon a detection signal of the passenger sensor; and
wherein the images captured by the second image pick-up device is stored in the memory device in the fourth mode.

7. The imaging system as in claim 1,
wherein the at least one sensor comprises a communication sensor that detects a radio communication; and
wherein the image pick-up modes comprise a fifth mode that is selected when the controller detects the radio communication based upon a detection signal of the communication sensor.

8. The imaging system as in claim 1;
wherein the at least one sensor comprises a speed sensor for detecting the traveling speed of the patrol car and a steering angle sensor for detecting a steering angle of the patrol car; and
wherein the controller is operable so as to estimate an orientation of a sight line based upon a detection signal from the speed sensor and a detection signal from the steering sensor; and
wherein the image-pick up modes include a sixth mode that is selected to control and manipulate at least one image-pick up device based upon the estimated orientation of the sight line.

9. The imaging system as in claim 1,
wherein the at least one sensor comprises a signal sensor for detecting a communication signal outputted from a portable communication device; and
wherein the controller is arranged and constructed to determine a direction of the portable communication device with respect to the patrol car based upon a detection signal from the signal sensor; and
wherein the image pick-up modes comprise a seventh mode that is selected to control and manipulate at least one image-pick up device based upon the determined direction of the portable communication device.

10. The imaging system as in claim 9,
wherein the signal sensor comprises a receiver for receiving the communication signal from the portable communication device.

11. The imaging system as in claim 1;
wherein the at least one sensor comprises a capacity sensor for detecting a remaining capacity of a power source of the imaging system; and
wherein the image pick-up mode comprises an eighth mode that is selected when the remaining capacity of the power source is less than a predetermined value based upon a detection signal from the capacity sensor.

12. A patrol car comprising an imaging system, the imaging system comprising:
at least one image pick-up device;
a memory device; and
a controller arranged and constructed to execute instructions to store image information captured by the image pick-up device in the memory device and to control the memory device and the at least one image pick-up device corresponding to a patrolling function.

13. A patrol car as in claim 12, wherein the controller comprises a control unit sized to be mounted into a storage space designed to accommodate a main body of audio equipment.

14. A patrol car as in claim 13, the controller further comprises a relay device arranged and constructed to connect between the at least one image pick-up device and the control unit; and
wherein the relay device is disposed externally to the storage space.

15. A patrol car as in claim 14, wherein the relay device is arranged and constructed to connect with at least one terminal device.

16. A patrol car comprising an imaging system, the imaging system comprising:
at least one image pick-up device arranged and constructed to capture image information;
a memory device arranged and constructed to store the image information captured by the at least one image pick-up device;
a positional information acquisition device arranged and constructed to obtain positional information of the patrol car, and
a transmitter arranged and constructed to transmit the image information and the positional information to a place external to the patrol car; and
an input device arranged and constructed to enable an instruction input to transmit the image information and the positional information via the transmitter, and
a controller arranged and constructed to transmit the image information and the positional information via the transmitter when a corresponding instruction is inputted into the input device.

17. The patrol car as in claim 16, wherein the image information and the positional information are transmitted in a single file format.

18. The patrol car as in claim 16, wherein the image information and the positional information are transmitted in a format of separate files.

19. The patrol car as in claim 16, wherein the imaging system further comprises:
a display device arranged and constructed to display the image information captured by the image pick-up device;
a buffer memory arranged and constructed to temporarily store the image information received from the image pick-up device or read from the memory device; and
wherein the transmitter transmits the image information stored in the buffer memory.

20. The patrol car as in claim 19, wherein the image information and the positional information are stored in the buffer memory in a file format.

21. The patrol car as claim 16, wherein the transmitter comprises a radio transmitter.

22. A patrol car comprising an imaging system, the imaging system comprising:
at least one image pick-up device arranged and constructed to capture images of at least one of either an outside environment or an inside environment of the patrol car and to output a corresponding image information; and
a memory device arranged and constructed to store the image information; and
a controller arranged and constructed to execute instructions to store the image information in the memory device and to output a synchronization signal to the image pick-up device; and
wherein the image information corresponding to one frame of image is outputted from the image pick-up device to the controller in response to the cyclic period of the synchronization signal.

23. The patrol car as in claim 22, further including a speed sensor for detecting a traveling speed of the patrol car, and
wherein the controller is further arranged and constructed to change the cyclic period of the synchronization signal in response to the detected traveling speed.

24. The patrol car as in claim 22, wherein the controller is further arranged and constructed to monitor a remaining storage capacity of the memory device and to indicate information corresponding to the remaining storage capacity to an operator of the imaging system.

25. The patrol car as in claim 24, wherein the controller monitors the remaining storage capacity when an engine of the patrol car is started, and the controller outputs an alert signal if the remaining storage capacity is lower than a predetermined level, and the controller outputs the alert signal if the memory device is not connected to the controller.

26. A patrol car comprising an imaging system, the imaging system comprising:
at least one image pick-up device arranged and constructed to capture images of at least one of either an outside environment or an inside environment of the patrol car and to output a corresponding image information; and
a memory device arranged and constructed to store the image information; and
a controller including a control unit and a relay device;
wherein the controller is arranged and constructed to execute instructions to store the image information in the memory device;
wherein the relay device receives a power supply from a battery mounted within the patrol car, and the power supply is supplied to the control unit, the image pick-up device, and the memory device, via the relay device; and
wherein the relay device is arranged and constructed to control a start-up timing of each of the control unit, the image pick-up device and the memory device.

27. The patrol car as in claim 26, wherein the controller is further arranged and constructed to monitor a remaining storage capacity of the memory device and to indicate a remaining storage capacity information with to an operator of the imaging system.

28. The patrol car as in claim 27, wherein the controller monitors the remaining storage capacity of the memory device each time an engine of the patrol car is started, and the controller outputs an alert signal if the remaining storage capacity is lower than a predetermined level, and the controller outputs the alert signal if the memory device is not connected to the controller.

29. A patrol car comprising an imaging system, the imaging system comprising;
at least one image pick-up device arranged and constructed to capture images of at least one of either an outside environment or an inside environment of the patrol car and to output a corresponding image information;
a memory device arranged and constructed to store the image information; and
a controller arranged and constructed to execute an instruction to store the image information in the memory device; and
wherein the controller includes a reading device arranged and constructed to obtain an identification information of an occupant of the patrol car and to stored the obtained identification information in the memory device.

30. The patrol car as in claim 29, wherein the controller is further arranged and constructed to monitor a remaining storage capacity of the memory device and to indicate a remaining storage capacity information to an operator of the imaging system.

31. The patrol car as in claim 30, wherein the controller monitors the remaining storage capacity when an engine of the patrol car is started, and the controller outputs an alert signal if the remaining storage capacity is lower than a predetermined level, and the controller outputs the alert signal if the memory device is not connected to the controller.

32. A patrol car comprising an imaging system, the imaging system comprising:
at least one image pick-up device arranged and constructed to capture images of at least one of either an outside environment or an inside environment of the patrol car and to output a corresponding image information;
a memory device arranged and constructed to store the image information; and
a controller arranged and constructed to execute an instruction to store the image information in the memory device; and
wherein the controller has an internal clock and is arranged and constructed to synchronize a time of the internal clock with a correct time at a predetermined interval.

33. The patrol car as in claim 32, wherein the controller is further arranged and constructed to monitor a remaining storage capacity of the memory device and to indicate a remaining storage capacity information to an operator of the imaging system.

34. The patrol car as in claim 33, wherein the controller monitors the remaining storage capacity when an engine of the patrol car is started, and the controller outputs an alert signal if the remaining storage capacity is lower than a predetermined level, and the controller outputs the alert signal if the memory device is not connected to the controller.
